(19) United States
(12) Patent Application Publication
(10) Pub. No.: US 2019/0255855 A1
(43) Pub. Date: Aug. 22, 2019

(54) INK CONNECTION NEEDLE, INK-FILLING JIG, AND CARTRIDGE

(71) Applicant: SEIKO EPSON CORPORATION, Tokyo (JP)

(72) Inventors: Daichi MIYASHITA, Matsumoto-shi (JP); Ichiro AOYAMA, Shiojiri-shi (JP)

(73) Assignee: SEIKO EPSON CORPORATION, Tokyo (JP)

(21) Appl. No.: 16/280,728

(22) Filed: Feb. 20, 2019

(30) Foreign Application Priority Data
Feb. 21, 2018 (JP) 2018-028550

(51) Int. Cl. B41J 2/175

(52) U.S. Cl. CPC B41J 2/17523; B41J 2/17509

(57) ABSTRACT

Provided is an ink connection needle increasing the flow speed of ink between a cartridge and an ink tank. The ink connection needle is connected to a cartridge provided with an ink container, a connection body connected to the ink container, and a sealing member that seals the connection body, such that one end of the ink connection needle is detachably connected to a connection port of the connection body, the other end is connected to an ink flow path, the ink connection needle including: a base end portion connected to the ink flow path a virtual axial line passing through a center of the ink communication port is inclined relative to an axial line in which a radial center of the leading end portion is an axial center.

### BACKGROUND

### 1. Technical Field

The present invention relates to an ink connection needle, an ink-filling jig, and a cartridge.

### 2. Related Art

In recent years, for example, large-sized cartridges that have a large capacity are used in industrial printers, and the printing speed has been increasing. In view of this, there is demand for further increasing the flow speed of ink from cartridges to printers (printing units) in order to cope with the increase in printing speed.

In addition, an ink-filling jig for filling a cartridge with ink in order to improve the productivity when filling, with ink, the above-mentioned large-sized cartridges that have a large capacity and that are used for printers (when injecting ink into such cartridges) is disclosed (for example, see JP-A-2011-16236).

JP-A-2011-16236 is an example of related art.

However, the above-described ink-filling jig has room for further increases in the speed of filling the cartridge with ink and the flow speed of ink from the inside of the cartridge to the outside (for example, an ink tank on the printing head side).

An advantage of some aspects of the invention is to provide an ink connection needle for increasing the flow speed of ink between a cartridge and an ink tank, for example.

The invention can be realized as the following modes or application example.

### SUMMARY

### Application Example 1

An ink connection needle according to this application example is connected to a cartridge provided with an ink container that contains ink, a connection body connected to the ink container, and a sealing member that seals the connection body, such that one end of the ink connection needle is detachably connected to a connection port of the connection body, the other end is connected to an ink flow path, and the ink can flow between the cartridge and an ink tank connected to the ink flow path, the ink connection needle including: a base end portion connected to the ink flow path and positioned on the ink tank side; and a leading end portion in which an ink communication port is formed, and that passes through the sealing member and is inserted into the connection port, and, in a state where the leading end portion is inserted into the connection port, a virtual axial line that passes through a center of the ink communication port is inclined relative to an axial line in which a radial center of the leading end portion is an axial center.

According to this configuration, it is possible to cause ink discharged from the cartridge via the ink connection needle to flow into the ink tank. It is also possible to cause ink discharged from the ink tank via the ink connection needle to flow into the cartridge.

Here, the virtual axial line that passes through the center of the ink communication port provided in the ink connection needle is inclined relative to the axial line in which the radial center of the leading end portion is the axial center. Accordingly, compared with a case where the ink communication port is formed such that the virtual axial line of the ink communication port is perpendicular to the axial line of the connection body, resistance to the flow of ink is small between the connection body on the cartridge side and the leading end portion on the ink connection needle side, and thus it is possible to increase the flow speed of ink from the cartridge to the ink tank. Therefore, for example, the speed of supply of ink to a printing head, which is the ink tank, increases, and it is possible to increase the printing speed. In addition, it is possible to increase the flow speed of ink from the ink tank to the cartridge. Therefore, the speed of filling the cartridge with ink increases, and the productivity of the cartridge can be increased.

### Application Example 2

The ink connection needle according to the above application example is provided with a plurality of ink communication ports, which are formed in a circumferential direction of the leading end portion.

According to this configuration, the flow rate of ink increases, and thus it is possible to further increase the flow speed of ink.

### Application Example 3

In the ink connection needle according to the above application example, a tip portion of the leading end portion is flat.

According to this configuration, a portion of the ink connection needle can come into surface contact with the mobile body, and it is possible to stabilize the connectability between the connection body and the ink connection needle.

### Application Example 4

In the ink connection needle according to the above application example, a space in which the ink flows is formed in at least a portion of a virtual region acquired by extending an outer contour of the ink communication port toward an inner wall of the connection body at an angle between a virtual axial line that passes through a center of the ink communication port and an axial line in which a center of the connection port of the connection body is an axial center.

According to this configuration, it is possible to reduce resistance to ink that flows in the vicinity of the ink communication port.

### Application Example 5

An ink-filling jig according to this application example is connected to a cartridge provided with an ink container that contains ink, a connection body connected to the ink container, and a sealing member that seals the connection body, such that one end of the ink-filling jig is detachably connected to a connection port of the connection body, the other end is connected to an ink flow path, and the ink can flow from an ink tank connected to the ink flow path to the cartridge, the ink-filling jig including: an ink connection needle that is connected to the connection body, and the ink connection needle includes a base end portion that is connected to the ink flow path and positioned on the ink tank side, and a leading end portion in which an ink communication port is formed, and that passes through the sealing member, and is inserted into the connection port, and, in a state where the leading end portion is inserted into the connection port, a virtual axial line in which a center of the ink communication port is an axial center is inclined relative to an axial line in which a center of the connection port of the connection body is an axial center.

According to this configuration, it is possible to cause ink discharged from the ink tank via the ink-filling jig to flow into the cartridge.

Here, the virtual axial line that passes through the center of the ink communication port provided in the ink connection needle of the ink-filling jig is inclined relative to the central axis of the connection port of the connection body. Accordingly, resistance to the flow of ink decreases between the connection body on the cartridge side and the leading end portion on the ink connection needle side, and thus it is possible to increase the flow speed of ink that flows from the ink tank to the cartridge. Therefore, the filling speed of the cartridge increases, and the productivity of the cartridge can be increased.

### Application Example 6

In the ink-filling jig according to the above application example, a tube diameter of the leading end portion of the ink connection needle through which the ink flows is smaller than a tube diameter of the base end portion through which the ink flows.

According to this configuration, the tube diameter is smaller on the leading end portion side than on the base end portion side, and thus the flow speed of ink increases. Accordingly, it is possible to increase the speed of filling the cartridge.

### Application Example 7

In the ink-filling jig according to the above application example, a space in which the ink flows is formed in at least a portion of a virtual region acquired by extending an outer contour of the ink communication port toward an inner wall of the connection body at an angle between a virtual axial line that passes through a center of the ink communication port and an axial line in which a center of the connection port of the connection body is a central axis.

According to this configuration, it is possible to reduce resistance to ink that flows in the vicinity of the ink communication port.

### Application Example 8

The cartridge according to this application example is filled with the ink using the above-described ink connection needle or the above-described ink-filling jig.

According to this configuration, it is possible to provide a cartridge having high productivity.

### BRIEF DESCRIPTION OF THE DRAWINGS

The invention will be described with reference to the accompanying drawings, wherein like numbers reference like elements.

FIG. 1 is a schematic diagram showing the configuration of a liquid consumption system.

FIG. 2 is a perspective view showing a liquid container and one end portion side of a first tube.

FIG. 3 is a perspective view showing the configuration of an attachment portion.

FIG. 4 is a perspective view showing the configuration of a liquid container (cartridge).

FIG. 5 is a perspective view of an enlarged portion of the liquid container (cartridge).

FIG. 6 is an exploded perspective view of the configuration of a connection body.

FIG. 7 is a perspective view showing the configuration of a supply member.

FIG. 8 is a perspective view showing the configuration of an intermediate member.

FIG. 9 is a perspective view showing the configuration of a connection member.

FIG. 10 is a rear view showing the configuration of the connection member.

FIG. 11 is a cross-sectional view showing the configuration of the connection body.

FIG. 12 is a perspective view showing the configuration of a liquid introduction needle (ink connection needle).

FIG. 13 is a partial cross-sectional view showing the configuration of the liquid introduction needle (ink connection needle).

FIG. 14 is a cross-sectional view showing a state where the liquid introduction needle (ink connection needle) is inserted into the connection body.

FIG. 15 is a schematic diagram showing an action of the liquid introduction needle (ink connection needle).

FIG. 16 is a schematic diagram showing the configuration of a liquid-filling jig (ink-filling jig).

FIG. 17 is a schematic diagram showing an action of the liquid-filling jig (ink-filling jig).

### DESCRIPTION OF EXEMPLARY EMBODIMENTS

Embodiments of the invention will be described below with reference to the drawings. Note that, in the following drawings, the scales of members and the likes are different from the actual scales such that the members and the like have recognizable sizes.

### First Embodiment

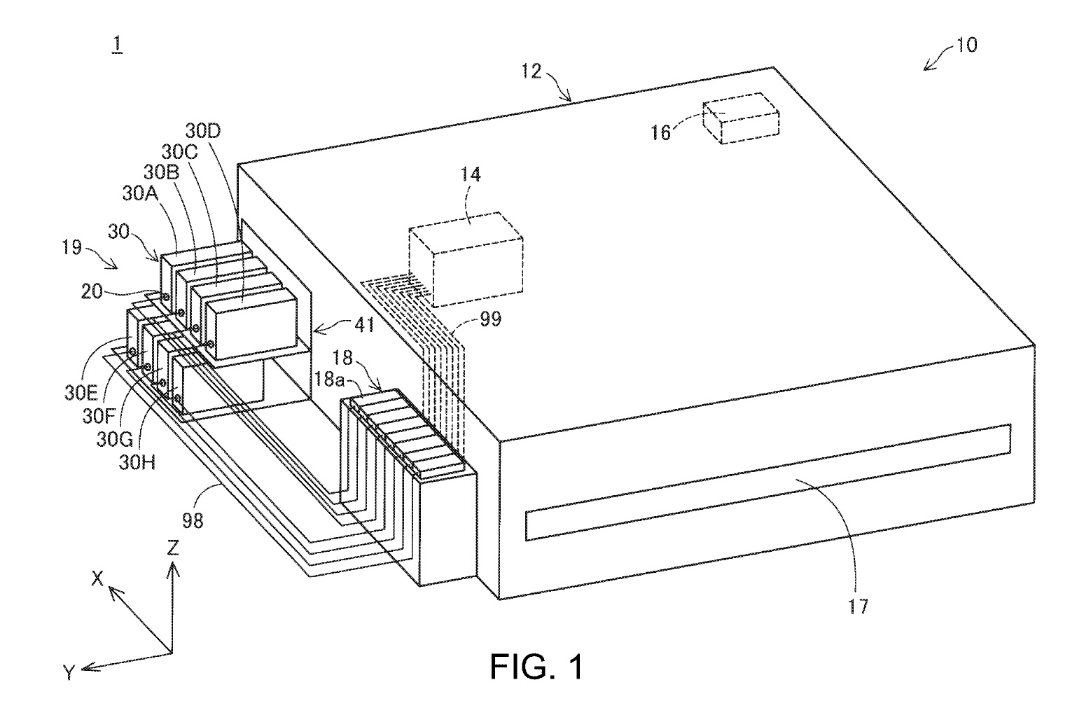

First, the configuration of a liquid consumption system will be described. FIG. 1 is a schematic diagram of a liquid consumption system 1 according to a first embodiment of the present invention. In FIG. 1, three mutually orthogonal spatial axes, namely, an X axis, a Y axis, and a Z axis, are shown. The direction that extends along the X axis will be defined as the X axis direction, the direction that extends along the Y axis will be defined as the Y axis direction, and the direction that extends along the Z axis will be defined as the Z axis direction. In an attached state in which a liquid container 30 (cartridge) is attached to an attachment portion 20, which will be described later, the gravity direction will be defined as the −Z axis direction, and the counter gravity direction will be defined as +Z axis direction. Likewise, in the attached state, one side of the X axis direction will be defined as the +X axis direction, and the other side of the X axis direction will be defined as the −X axis direction. In the attached state, the liquid consumption system 1 is installed on a plane (X-Y plane) that is parallel to the X axis direction and the Y axis direction. The X axis, the Y axis, and the Z axis in the attached state are also shown in the other diagrams described below where necessary.

As shown in FIG. 1, the liquid consumption system 1 includes a liquid consumption apparatus 10, liquid containers 30, a main shelf 19, and a sub shelf 18. The liquid consumption apparatus 10 is an inkjet textile printing machine that ejects ink, which is an example of a liquid, onto a medium such as a fabric product so as to perform recording (printing). Note that the liquid consumption apparatus 10 may be a printer that ejects ink onto paper so as to perform recording (printing).

In this embodiment, eight liquid containers 30 are provided. The eight liquid containers 30 contain liquids (inks) of different colors. Where it is necessary to make a distinction between the eight liquid containers 30, reference numerals 30A to 30H will be used. A liquid container 30A contains a cyan (C) liquid. A liquid container 30B contains a magenta (M) liquid. A liquid container 30C contains a yellow (Y) liquid. A liquid container 30D contains a black (K) liquid. A liquid container 30E contains a red (R) liquid. A liquid container 30F contains a blue (B) liquid. A liquid container 30G contains an orange (O) liquid. A liquid container 30H contains a gray (LK) liquid. Note that the number of liquid containers 30 may be less than 8, or may be greater than 8.

The main shelf 19 is provided on the outside of the liquid consumption apparatus 10, and the eight liquid containers 30 are disposed thereon. The main shelf 19 has a two-level configuration, with the liquid containers 30A to 30D being disposed on the upper level, and the liquid containers 30E to 30H being disposed on the lower level. In the main shelf 19, one end portions of first tubes 98, which will be described later, are provided.

Eight sub tanks 18a are disposed on the sub shelf 18. The eight sub tanks 18a are provided so as to correspond to the eight liquid containers 30A to 30H. The liquid containers 30A to 30H and the corresponding sub tanks 18a are in communication with each other via flexible first tubes 98. Eight first tubes 98 are provided so as to correspond to the liquid containers 30A to 30H. The liquids contained in the liquid containers 30A to 30H are supplied to the corresponding sub tanks 18a through the first tubes 98 by a vacuum mechanism (not shown) provided in the liquid consumption system 1, the vacuum mechanism being, for example, a pump (not shown) disposed on the sub shelf 18.

The liquid consumption apparatus 10 includes an outer shell 12, a liquid consumption portion 14 (ink tank), a control portion 16, first tubes 98, attachment portions 20, and second tubes 99. The outer shell 12 has a substantially rectangular parallelepiped outer shape. The outer shell 12 forms the outer surface of the liquid consumption apparatus 10.

The liquid consumption portion 14 is disposed within the outer shell 12. The liquid consumption portion 14 is in communication with the sub tanks 18a via the flexible second tubes 99 that are provided corresponding to the sub tanks 18a. Liquid is supplied to the liquid consumption portion 14 via the second tubes 99. In the present embodiment, the liquid contained in the sub tanks 18a is supplied to the liquid consumption portion 14 via the second tubes 99 by a pressurizing mechanism such as, for example, a pump (not shown) provided in the liquid consumption apparatus 10. The liquid consumption portion 14 includes an ejection head for ejecting liquid onto a medium such as a fabric product. The liquid consumption portion 14 is reciprocatingly moved in the Y axis direction by a driving mechanism (not shown) provided in the liquid consumption apparatus 10. The liquid consumption portion 14 is reciprocatingly moved in the Y axis direction while ejecting liquid, and the medium is moved in the outer shell 12 from the +X axis direction side toward the −X axis direction side by a conveyance mechanism (not shown) provided in the liquid consumption apparatus 10. The liquid is thereby ejected onto the medium. The medium onto which a liquid has been ejected is discharged to the outside of the outer shell 12 through a discharge outlet 17 provided in a surface (front surface) of the outer shell 12 that is located on the −X axis direction side. As another embodiment, the liquid consumption portion 14 may be a line head that is not reciprocatingly moved and is fixed.

The control portion 16 is disposed within the outer shell 12. The control portion 16 controls the operations of the liquid consumption apparatus 10. For example, the control portion 16 controls the operations of the driving mechanism and the conveyance mechanism described above. Also, the control portion 16 is electrically connected to the liquid containers 30, and is therefore capable of exchanging various types of information with the liquid containers 30. The various types of information may include, for example, the liquid color information of each liquid container 30, information indicating whether or not each liquid container 30 is attached to the liquid consumption apparatus 10, and the like.

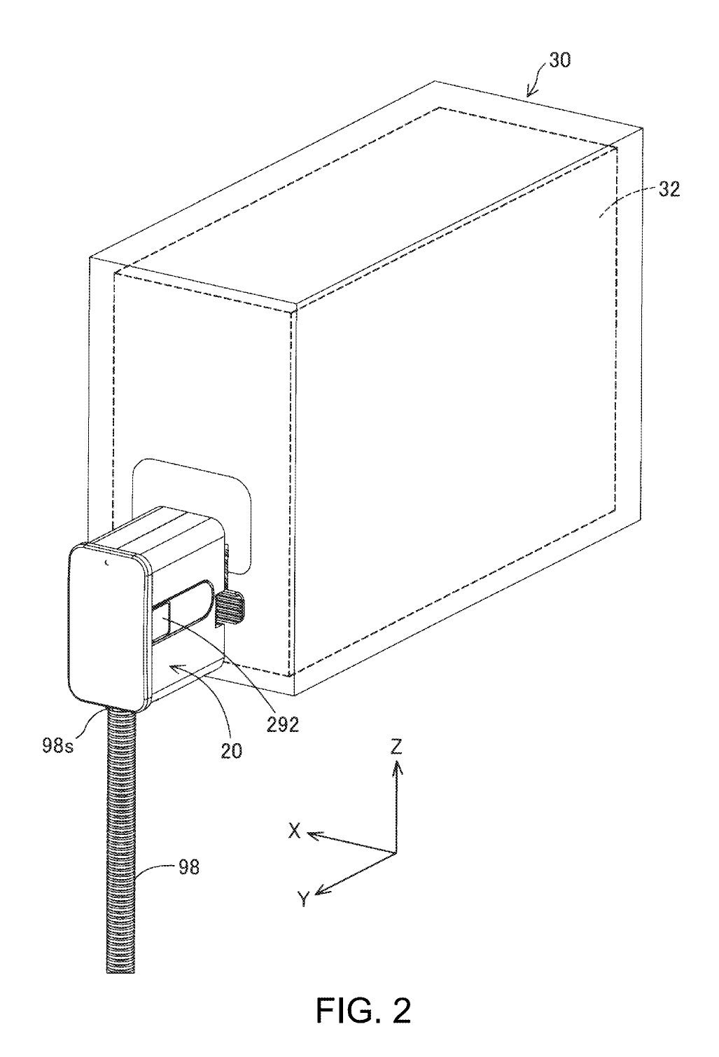

FIG. 2 is a perspective view of a liquid container 30 and one end portion 98s side of a first tube 98. FIG. 2 shows an attached state in which the liquid container 30 is attached to the attachment portion 20. The attachment portion 20 is connected to the one end portion 98s of the first tube 98. The attachment portion 20 is detachably attached to the liquid container 30. Specifically, the attachment portion 20 is moved toward the liquid container 30 disposed on the main shelf 19 (see FIG. 1), and the attachment portion 20 is attached to the liquid container 30. The direction in which the attachment portion 20 is attached to the liquid container 30 is the −Y axis direction, and the direction in which the attachment portion 20 is detached from the liquid container 30 is the +Y axis direction. The attachment direction is based on a direction immediately before the attachment portion 20 is attached to the liquid container 30, and the detachment direction is based on a direction immediately after an operation to detach the attachment portion 20 from the liquid container 30. That is, a direction (attachment direction) in which the liquid container 30 is moved relative to the attachment portion 20 when the liquid container 30 is attached to the attachment portion 20 is the +Y axis direction. Also, a direction (detachment direction) in which the liquid container 30 is moved relative to the attachment portion 20 when the liquid container 30 is detached from the attachment portion 20 is the −Y axis direction.

The attachment portion 20 includes releasing portions 292 on both sides in the X axis direction (only one disengagement portion 292 is shown in FIG. 2). As a result of the releasing portions 292 being pressed, the engagement between the attachment portion 20 and the liquid container 30 is released, and the attachment portion 20 can be detached from the liquid container 30. In the attached state, a liquid contained in a liquid supply source 32 included in the liquid container 30 is supplied to the attachment portion 20. The liquid supplied to the attachment portion 20 flows through the first tube 98.

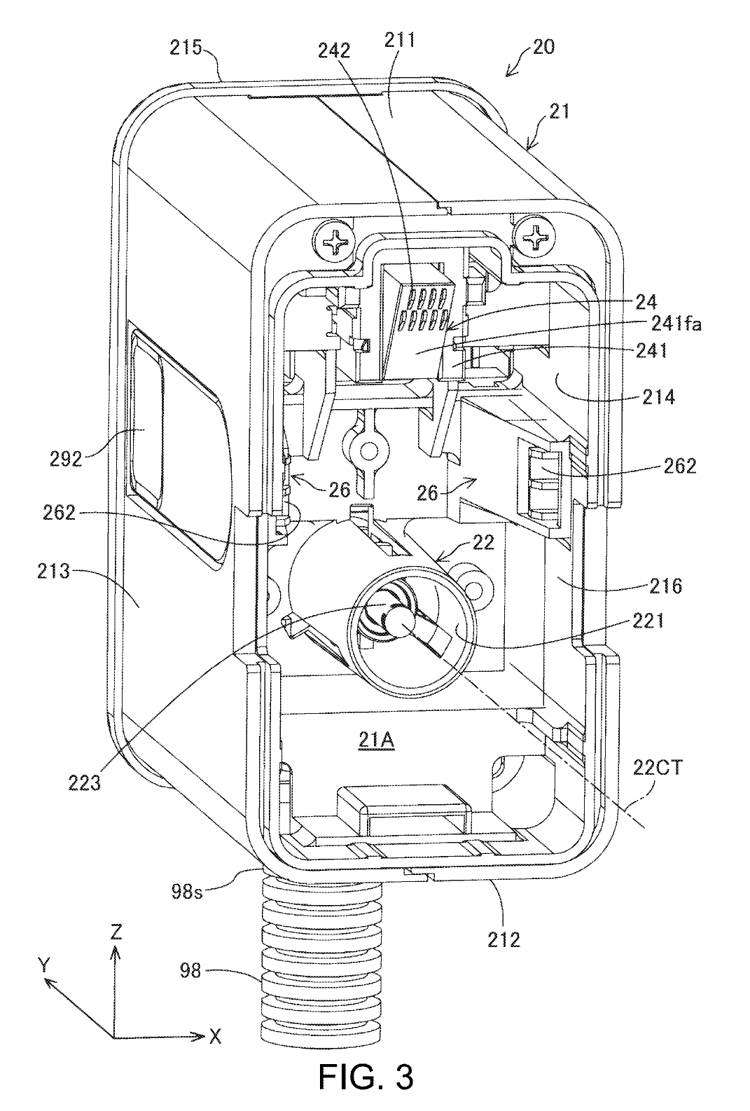

Next, the configuration of the attachment portion will be described. FIG. 3 is a perspective view showing the configuration of the attachment portion. Note that, for the sake of ease of understanding, FIG. 3 also shows the one end portion 98s side of the first tube 98.

As shown in FIG. 3, the attachment portion 20 includes an attachment portion outer shell 21 that forms its outer surface. The attachment portion outer shell 21 has a substantially rectangular parallelepiped outer shape. It can be said that the attachment portion outer shell 21 is a recess portion that has an opening on the −Y axis direction side thereof. The attachment portion outer shell 21 includes an attachment portion first surface (attachment portion first wall) 211, an attachment portion second surface (attachment portion second wall) 212, an attachment portion third surface (attachment portion third wall) 213, an attachment portion fourth surface (attachment portion fourth wall) 214, an attachment portion fifth surface (attachment portion fifth wall) 215, and an opening portion 216.

In the attached state in which a liquid container 30 is attached to the attachment portion 20, the attachment portion first surface 211 forms an upper surface, and the attachment portion second surface 212 forms a bottom surface. Also, the attachment portion third surface 213 forms one side surface, and the attachment portion fourth surface 214 forms another side surface. The attachment portion fifth surface 215 forms a recess bottom portion. The opening portion 216 opposes the attachment portion fifth surface 215, and defines an opening through which a portion of the liquid container 30 passes during attachment. The attachment portion first surface 211 and the attachment portion second surface 212 oppose each other in the Z axis direction. The attachment portion third surface 213 and the attachment portion fourth surface 214 oppose each other in the X axis direction. The attachment portion fifth surface 215 and the opening portion 216 oppose each other in the Y axis direction. The attachment portion first surface 211, the attachment portion second surface 212, the attachment portion third surface 213, the attachment portion fourth surface 214, and the attachment portion fifth surface 215 define a housing space 21A that houses a portion of the liquid container, and will be described later.

The attachment portion 20 further includes a liquid introducing portion 22, an apparatus-side electric mechanism portion 24, and engagement portions 26. The liquid introducing portion 22, the apparatus-side electric mechanism portion 24, and the engagement portions 26 are disposed in the housing space 21A that forms the interior of the attachment portion 20.

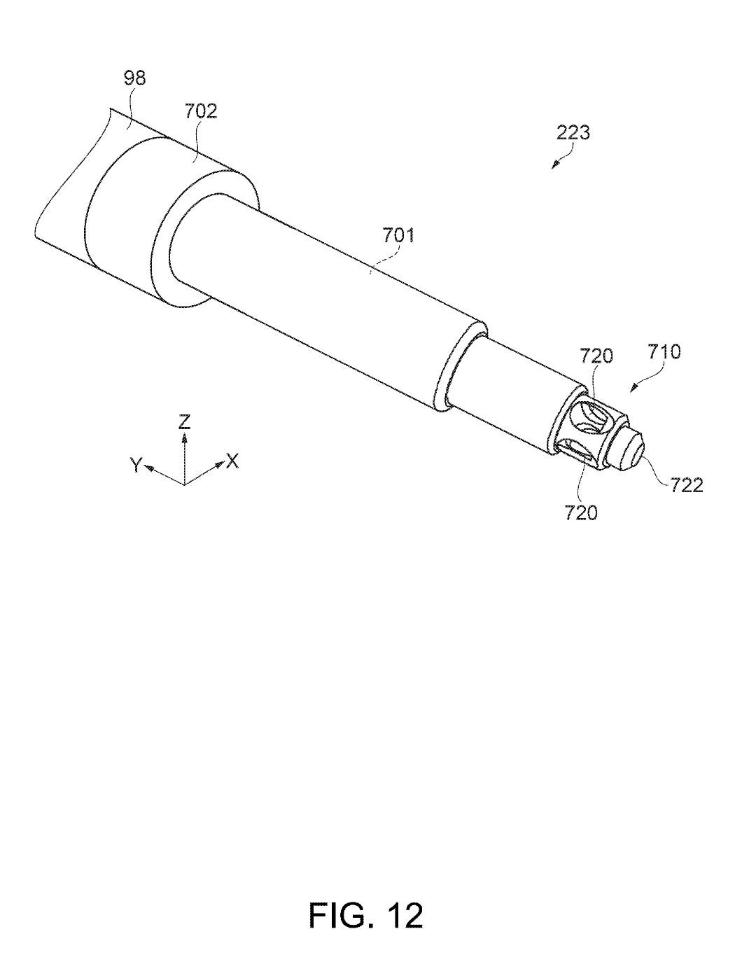

The liquid introducing portion 22 includes a liquid introducing needle 223 (ink connection needle) and an attachment portion-side tubular portion 221. The liquid introducing needle 223 has a central axis 22CT that extends in the Y axis direction. The liquid introducing needle 223 is hollow inside, and internally includes a flow path through which a liquid flows. In the attached state, the liquid introducing needle 223 is connected to a liquid supply portion, which will be described later, of the liquid container 30, and the liquid from the liquid supply portion flows into the inside of the liquid introducing needle 223. A proximal end portion (+Y axis direction-side end portion, see FIG. 12) 702 of the liquid introducing needle 223 is in communication with the first tube 98. Note that the configuration of the liquid introducing needle 223 will be described later in detail.

The attachment portion-side tubular portion 221 surrounds an outer circumference of the liquid introducing needle 223 about the central axis 22CT. Also, the attachment portion-side tubular portion 221 houses the liquid introducing needle 223. The attachment portion-side tubular portion 221 has an opening in its −Y axis direction-side end portion. The central axis of the attachment portion-side tubular portion 221 is the same as the central axis of the liquid introducing needle 223.

The apparatus-side electric mechanism portion 24 includes electric connection portions 242 that serve as terminals, and a pedestal 241 on which the electric connection portions 242 are disposed. In the attached state, the apparatus-side electric mechanism portion 24 is located on the counter gravity direction side (+Z axis direction side) relative to the liquid introducing portion 22.

Each electric connection portion 242 is a plate-like metal member and is elastically deformable. A portion of each electric connection portion 242 is exposed from a surface 241fa of the pedestal 241. The normal vector of the surface 241fa is a direction that includes a −Z axis direction component and a −Y axis direction component. Nine electric connection portions 242 are provided. The electric connection portions 242 are electrically connected to the control portion 16 (see FIG. 1) via wires (not shown).

Two engagement portions 26 are provided. In the attached state of the liquid container 30, each engagement portion 26 includes an engaging claw 262 at its −Y axis direction-side end portion. As a result of the engagement portions 26 being engaged with a portion of the liquid container 30, the engagement portions 26 restrict movement of the liquid container 30 relative to the attachment portion 20 at least in the Y axis direction.

As a result of the releasing portions 292 provided in the attachment portion third surface 213 and the attachment portion fourth surface 214 (only one releasing portion 292 is shown in FIG. 3) being pressed, the engaging claws 262 are displaced outward of the housing space 21A, and the engagement between the engagement portions 26 and the liquid container 30 is thereby released.

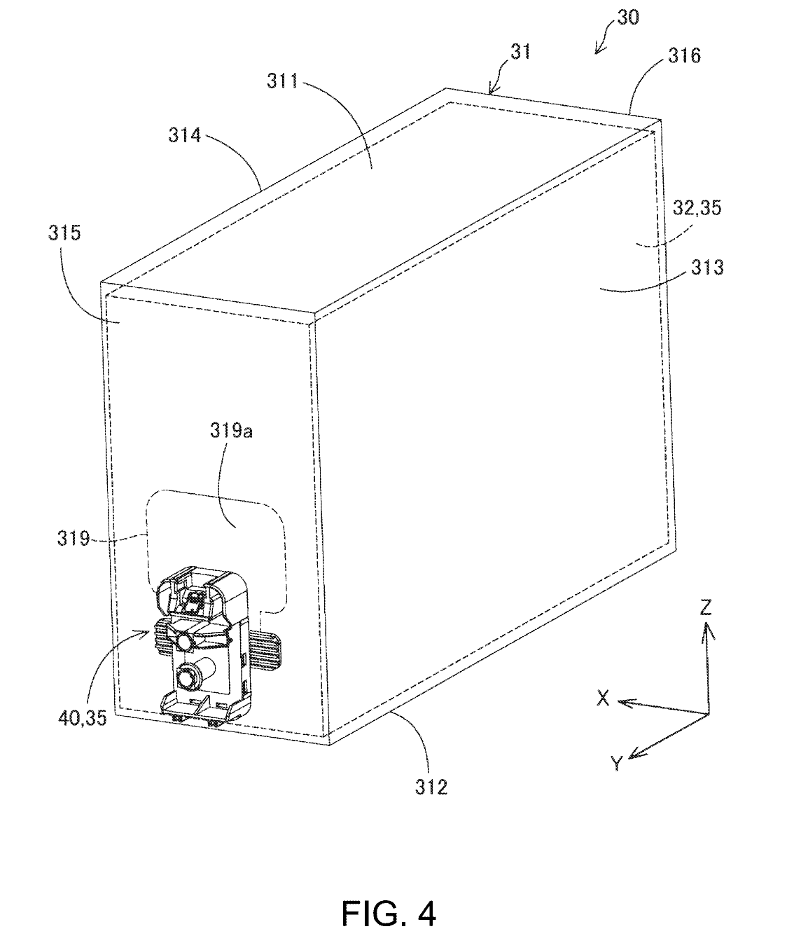

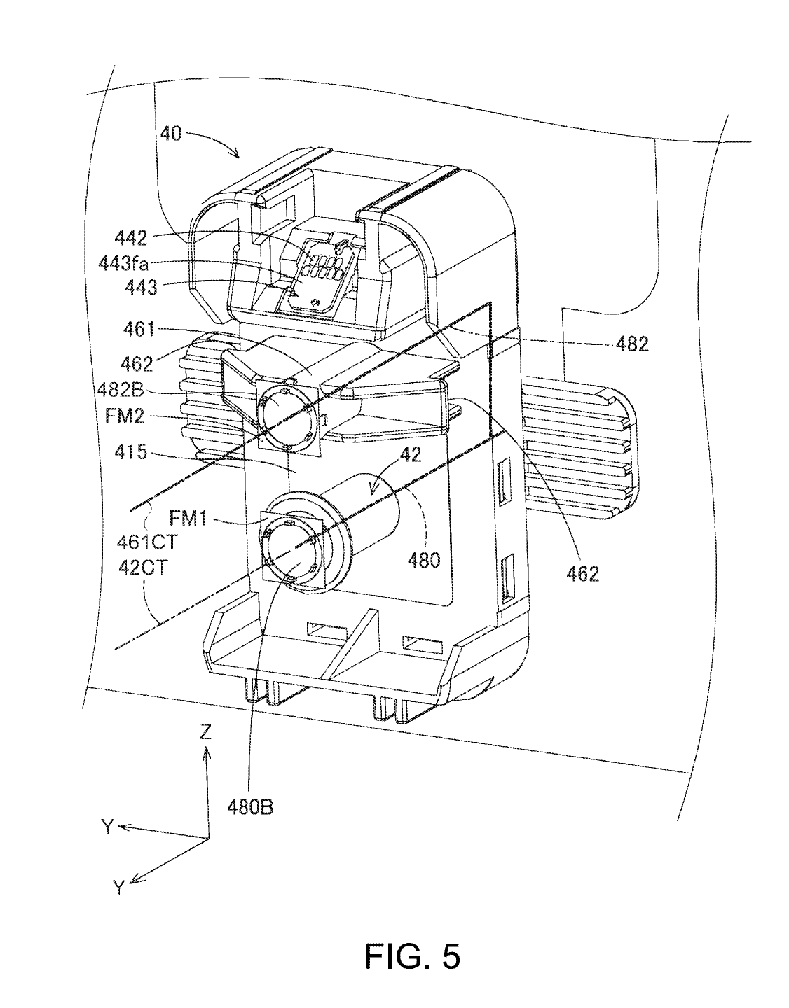

Next, the configuration of a liquid container will be described. FIG. 4 is a perspective view showing the configuration of a liquid container. FIG. 5 is a perspective view of an enlarged portion of the liquid container.

As shown in FIG. 4, the liquid container 30 includes a liquid housing body 35 and a case 31. The liquid housing body 35 has the liquid supply source 32 (ink housing portion) and a connection body 40. The liquid supply source 32 contains liquid (ink) to be supplied to the attachment portion 20. The liquid supply source 32 is a bag-like body, and is filled with a liquid. The liquid supply source 32 is in communication with a liquid supply portion of the connection body 40, which will be described later. The liquid housing body 35 is replaced with a new one when the liquid in the liquid supply source 32 is consumed and the remaining amount reaches zero or almost zero.

The connection body 40 is detachable from the attachment portion 20. The connection body 40 has a supply flow path 480 for supplying liquid from the liquid supply source 32 to the attachment portion 20. The connection body 40 is connected to the liquid supply source 32. The connection body 40 is electrically connected to the electric connection portions 242 of the attachment portion 20, and is connected to the liquid introducing needle 223 of the attachment portion 20. Accordingly, electric signals can be exchanged between the liquid container 30 and the control portion 16 (see FIG. 1), and liquid in the liquid supply source 32 can be supplied to the liquid consumption portion 14. The configuration of the connection body 40 will be described later in detail.

The case 31 houses the liquid supply source 32 removably. The case 31 has a substantially rectangular parallelepiped outer shape. In this embodiment, the case 31 is made from cardboard. The case 31 is made of, for example, a material composed mainly of cellulose. Note that, according to another embodiment, the case 31 may be formed of another member (made of a synthetic resin such as polypropylene or polyethylene). The case 31 has a first case surface (first case wall) 311, a second case surface (second case wall) 312, a third case surface 313 (third case wall) 313, a fourth case surface (fourth case wall) 314, a fifth case surface (fifth case wall) 315, and a sixth case surface (sixth case wall) 316.

In the attached state of the liquid container 30, the first case surface 311 forms the upper surface, and the second case surface 312 forms the bottom surface. In addition, the third case surface 313 forms one side surface, and the fourth case surface 314 forms another side surface. The fifth case surface 315 forms the front surface that faces the attachment portion 20, and the sixth case surface 316 forms the back face. The first case surface 311 and the second case surface 312 oppose each other in the Z axis direction. The third case surface 313 and the fourth case surface 314 oppose each other in the X axis direction. The fifth case surface 315 and the sixth case surface 316 oppose each other in the Y axis direction. The connection body 40 is inserted through the fifth case surface 315. Accordingly, a portion of the connection body 40 is exposed to the outside. Note that, when the liquid container 30 is not in use such as when it is being transported, the entire connection body 40 can be housed in the case 31. For example, by opening an opening/closing lid 319a formed of a cut line 319 formed in the fifth case surface 315, the connection body 40 can be housed in the case 31. Note that, according to another embodiment, the liquid container 30 does not need to have the case 31.

As shown in FIG. 5, the connection body 40 includes a liquid supply portion 42, a circuit substrate 443, a liquid injection portion 461, and engagement portions 462. These constituent elements 42, 443, 461, and 462 are arranged on a surface (front surface) 415 side of the connection body 40 that faces the attachment portion 20.

The liquid supply portion 42 is detachably connected to the liquid introducing portion 22 (specifically, the liquid introducing needle 223) of the attachment portion 20, and supplies liquid to the liquid introducing portion 22 (specifically, the liquid introducing needle 223). In an attaching process and attached state of the liquid container 30, the liquid supply portion 42 is inserted into the attachment portion-side tubular portion 221 of the liquid introducing portion 22.

The liquid supply portion 42 is a cylindrical member extending from the surface 415. An opening 480B (connection port) that receives the liquid introducing needle 223 is formed in the leading end of the liquid supply portion 42. The opening 480B is the downstream end of the supply flow path 480 in the flow direction (supply channel direction) of liquid that flows from the connection body 40 to the attachment portion 20. Thus, the opening 480B is also referred to as “downstream end 480B. In an unused state before the liquid container 30 is attached to the attachment portion 20, a film FM1 is attached to the opening 480B to block the opening 480B. When the liquid container 30 is attached to the attachment portion 20, the film FM1 is torn by the liquid introducing needle 223 (see FIG. 3). Note that, in another embodiment, the film FM1 may be removed by the user before the liquid container 30 is attached to the attachment portion 20. The liquid supply portion 42 further has a central axis 42CT extending in a direction along the +Y axis direction (the Y axis direction).

The liquid supply portion 42 further has a valve mechanism (not shown) for opening/closing the supply flow path 480, which is arranged in the flow path. The valve mechanism is opened by the liquid introducing needle 223 being inserted into the liquid supply portion 42.

The circuit substrate 443 has main-body-side terminals 442 provided in an arrangement surface 443fa, and a storage apparatus (not shown) provided in its rear surface. The storage apparatus of the circuit substrate 443 stores information regarding the liquid container 30 (for example, color information of liquid and information regarding the liquid residual amount), and the like.

The normal vector of the arrangement surface 443fa represents a direction including a +Z axis direction component and a +Y axis direction component. Nine main-body-side terminals 442 are arranged on this arrangement surface 443fa. In the attached state, the nine main-body-side terminals 442 come into contact with the corresponding electric connection portions 242 (see FIG. 3). Accordingly, signals can be exchanged between the control portion 16 (see FIG. 1) and the storage apparatus.

In the attached state, the engagement portions 462 are engaged with the engaging claws 262 (see FIG. 3). Due to this engagement, in the attached state, movement of the connection body 40 in a direction (the −Y axis direction) in which the liquid container 30 is detached from the attachment portion 20 is restricted. There are two engaging claws 262. The engaging claws 262 are surfaces facing the −Y axis direction.

The liquid injection portion 461 is a cylindrical member that extends in the Y axis direction. The liquid injection portion 461 forms a portion of an injection flow path 482 that is joined to the supply flow path 480. The injection flow path 482 is a flow path that allows a liquid to flow into the liquid supply source 32 from the outside. As a result of a liquid being injected from the liquid injection portion 461, the liquid can be injected into the liquid supply source 32 through the injection flow path 482. After the liquid is injected into the liquid supply source 32, the liquid injection portion 461 is blocked by a film FM2 to prevent the liquid from leaking to the outside. In addition, a valve mechanism for preventing liquid from leaking to the outside may be arranged in the liquid injection portion 461.

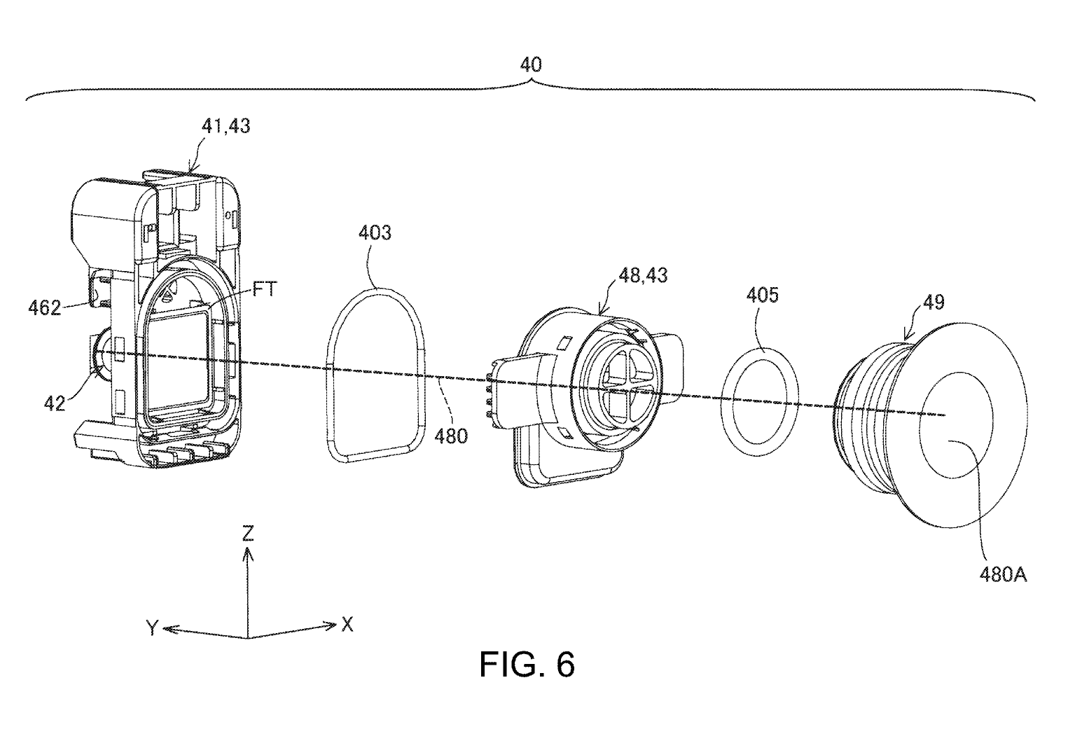

Next, the configuration of a connection body will be described. FIG. 6 is an exploded perspective view showing the configuration of a connection body. As shown in FIG. 6, the connection body 40 includes a supply member 49, a connection main body member 43, a first elastic sealing member 405, a second elastic sealing member 403, and a filter FT. Note that, in FIG. 6, a third elastic sealing member, which will be described later, is arranged in an intermediate member 48, and is not shown.

The supply member 49 forms an upstream end 480A of the supply flow path 480 in a flow direction of liquid flowing from the connection body 40 to the attachment portion 20. The supply member 49 is made of a synthetic resin. In this embodiment, the supply member 49 is made of a material composed mainly of polyethylene (PE). In this embodiment, a main composition refers to a composition whose weight % in the material is 50 weight % or more.

In the flow direction, the connection main body member 43 forms a downstream end 480B of the supply flow path 480 (see FIG. 5). The connection main body member 43 has the liquid supply portion 42, and, in the attached state, is connected to the liquid introducing needle 223 of the attachment portion 20.

The connection main body member 43 includes the intermediate member 48 and a connection member 41. The connection main body member 43 is formed by fitting the intermediate member 48 and the connection member 41 to each other. Accordingly, the connection member 41 is connected to the intermediate member 48. The intermediate member 48 is positioned to be sandwiched by the connection member 41 and the supply member 49. The intermediate member 48 and the connection member 41 are made of a synthetic resin. In this embodiment, the intermediate member 48 and the connection member 41 are each made of a material composed mainly of polypropylene (PP). Commonly, polypropylene is harder than polyethylene. Thus, it is possible to reduce the likelihood of the intermediate member 48 and the connection member 41 plastically deforming due to stress that occurs in a portion at which the intermediate member 48 and the connection member 41 are fitted to each other. In addition, polypropylene is a commonly versatile material, and is inexpensive. Thus, it is possible to reduce the manufacturing cost of the connection body 40.

The connection body 40 is formed by fitting the connection member 41 and the intermediate member 48 (specifically, one side of the intermediate member 48) to each other, and fitting the intermediate member 48 (specifically, the other side of the intermediate member 48) and the supply member 49 to each other.

The first elastic sealing member 405 seals the gap between the intermediate member 48 and the supply member 49 fitted to each other. The first elastic sealing member 405 has a ring-like shape, and is arranged to circumferentially surround the supply flow path 480. The first elastic sealing member 405 suppresses leakage, to the outside, of a liquid that flows from the gap between the intermediate member 48 and the supply member 49 to the supply flow path 480. The first elastic sealing member 405 is an elastic member, and, for example, is made of a material composed mainly of polybutadiene.

The second elastic sealing member 403 seals the gap between the connection member 41 and the intermediate member 48 fitted with each other. The second elastic sealing member 403 has a frame-like shape, and is arranged to circumferentially surround the supply flow path 480. The second elastic sealing member 403 suppresses leakage, to the outside, of a liquid that flows through the supply flow path 480 from the gap between the connection member 41 and the intermediate member 48. The second elastic sealing member 403 is an elastic member, and is made of a material composed mainly of polybutadiene, for example.

The filter FT is arranged in the supply flow path 480. The filter FT is a plate-like member made of a metal such as stainless steel. The filter FT is attached to a portion of the connection member 41. Examples of an attachment method include a method for heat-melting a portion of the connection member 41, pressing the melted portion into a portion of the opening of the filter FT, and allowing the melted portion to solidify. The filter FT has a rectangular outer shape. The filter FT has a mesh structure with openings that are sized to allow the passage of a liquid that flows through the supply flow path 480, and to not allow passage of extraneous materials such as dust in the liquid. The filter FT suppresses passage of extraneous materials in the liquid that flows through the supply flow path 480. Accordingly, in the flow direction, even if an extraneous material is mixed into liquid that flows from the upstream side of the filter FT to the downstream side of the filter FT, it is possible to reduce the likelihood of the extraneous material reaching the attachment portion 20. Accordingly, it is possible to reduce the likelihood of the ejection head of the liquid consumption portion 14 (see FIG. 1) being clogged by extraneous material. Note that the material of the filter FT is not limited to a metal, and the filter FT may be a member made of another material such as a synthetic resin.

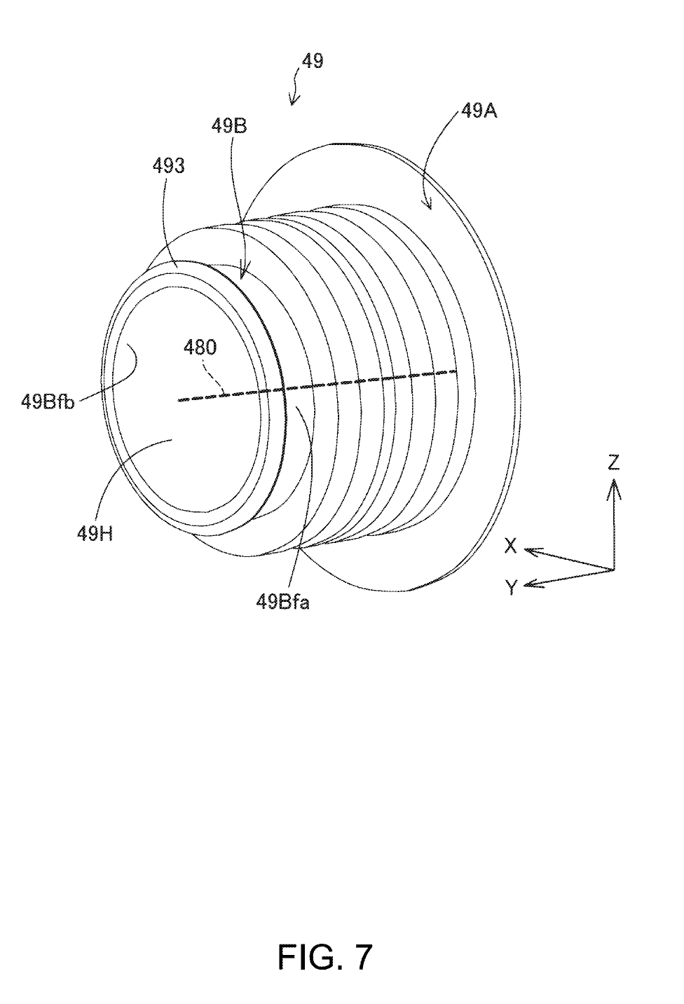

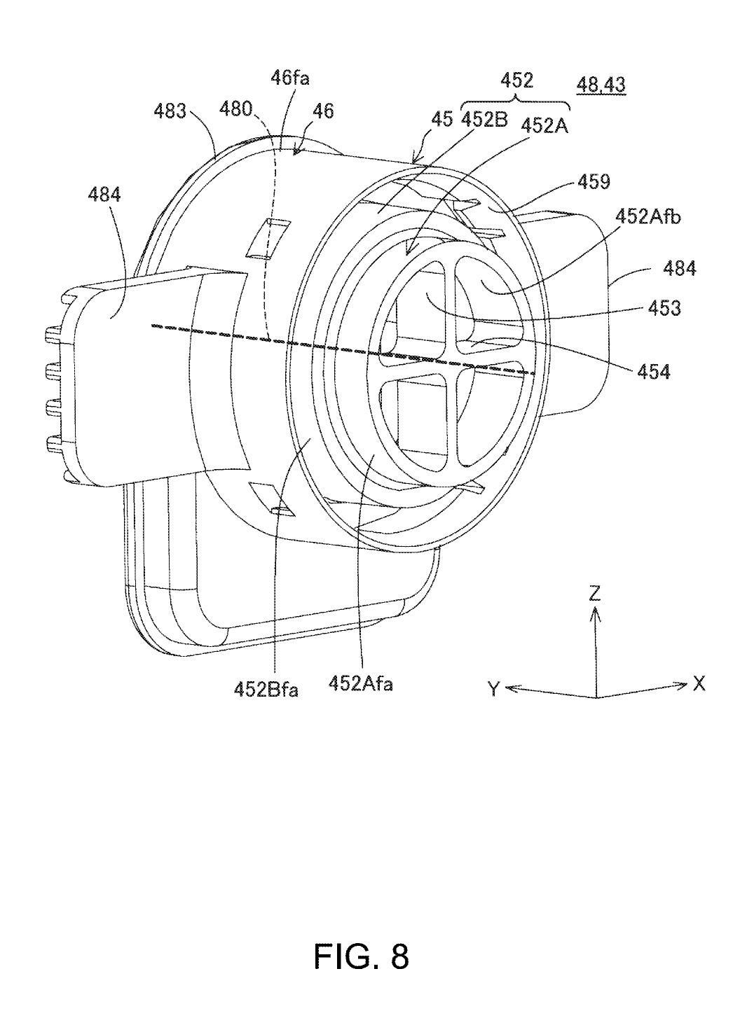

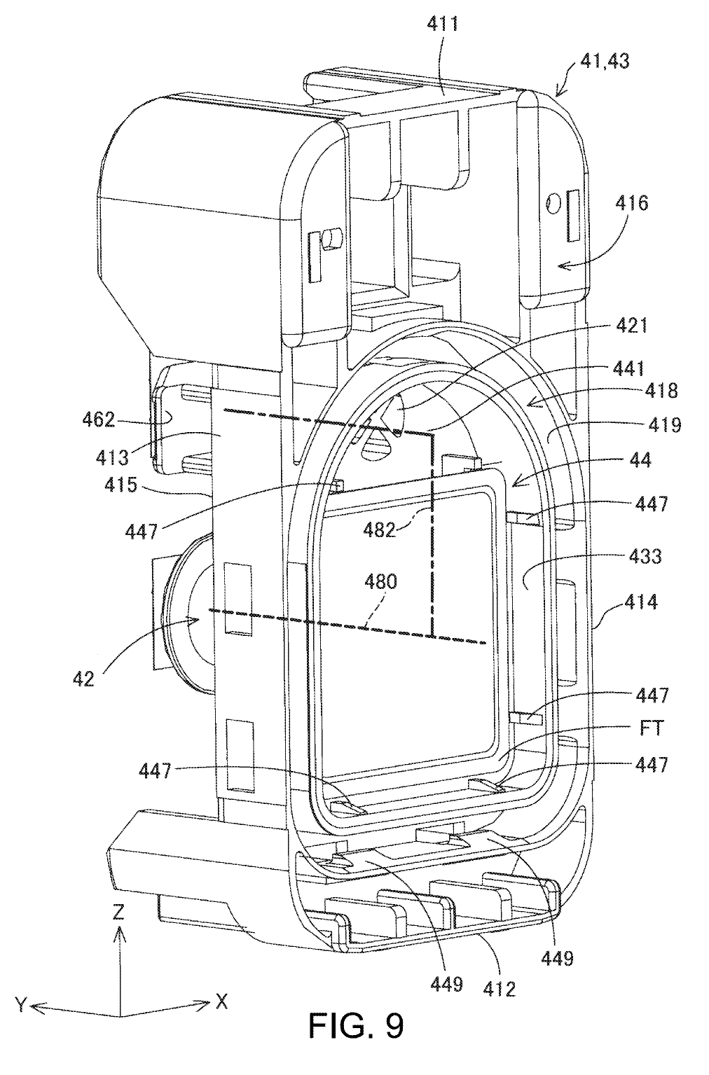

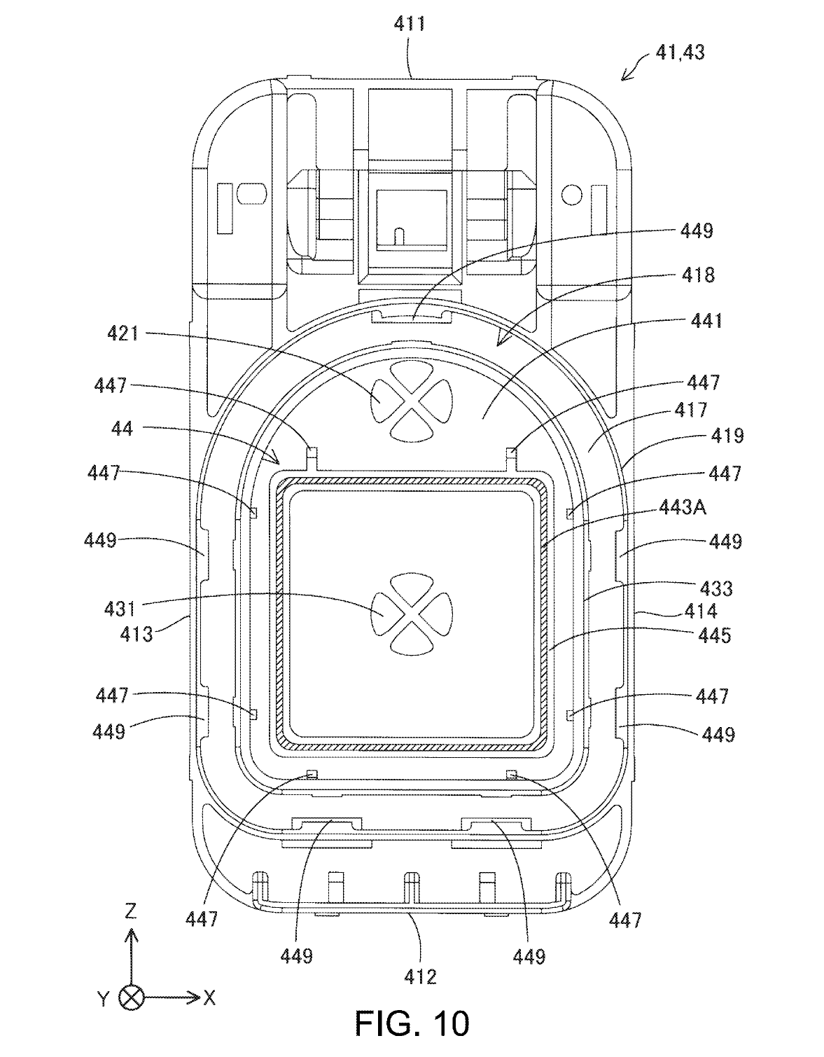

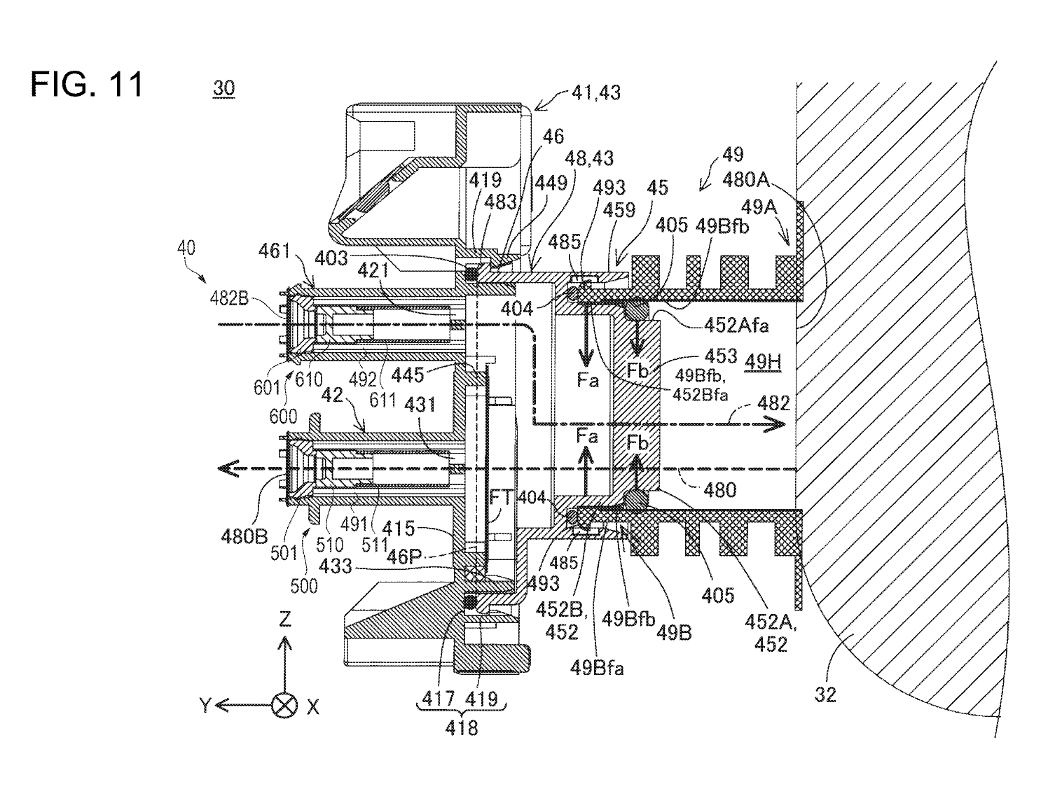

FIG. 7 is a perspective view of the supply member 49, and FIG. 8 is a perspective view of the intermediate member 48. In addition, FIG. 9 is a perspective view of the connection member 41. FIG. 10 is a rear view of the connection member 41. FIG. 10 shows the connection member 41 from which the filter FT has been removed. FIG. 11 is a cross-sectional view showing the configuration of the connection body 40.

As shown in FIG. 7, the supply member 49 is a cylindrical member, and has a through hole 49H formed therein, the through hole 49H constituting a portion of the supply flow path 480. The through hole 49H extends along the Y axis direction.

The supply member 49 has a first supply opening portion 49A that is one end portion and a second supply opening portion 49B that is the other end portion. The first supply opening portion 49A has a ring-like shape. The first supply opening portion 49A is connected to the liquid supply source 32 through heat welding, laser welding, or the like. The first supply opening portion 49A includes the upstream end 480A of the supply flow path 480 (see FIG. 11). Liquid that is supplied from the liquid supply source 32 to the connection body 40 first passes through the upstream end 480A.

The second supply opening portion 49B is positioned downstream of the first supply opening portion 49A in the flow direction. The second supply opening portion 49B has a cylindrical shape. The second supply opening portion 49B has an engaging claw 493 protruding radially outward from an outer peripheral surface 49Bfa. The engaging claw 493 is formed over the entire circumference of the outer peripheral surface 49Bfa. A portion of the intermediate member 48 (a fitting portion 452 to be described later) is fitted into the second supply opening portion 49B (see FIG. 11). In addition, the second supply opening portion 49B is fitted into another portion of the intermediate member 48 (a sealing main body member 459 to be described later). By engaging with the intermediate member 48, the engaging claw 493 suppresses detachment of the supply member 49 from the intermediate member 48. This connection mode between the supply member 49 and the intermediate member 48 will be described later. An inner peripheral surface 49Bfb of the second supply opening portion 49B has a portion that comes into surface contact with the intermediate member 48 over the entire periphery.

As shown in FIG. 8, one end portion 46 on the +Y axis direction side of the intermediate member 48 is connected to the connection member 41, and the other end portion 45 on the −Y axis direction side is connected to the supply member 49. In the intermediate member 48, a portion of the supply flow path 480 is formed. The other end portion 45 of the intermediate member 48 has the fitting portion 452 and the sealing main body member 459.

The fitting portion 452 (see FIG. 11) is fitted into the second supply opening portion 49B, and forms a portion of the supply flow path 480. The fitting portion 452 (see FIG. 8) has a cylindrical first fitting portion 452A and a cylindrical second fitting portion 452B that has a larger diameter than the first fitting portion 452A. The first fitting portion 452A is positioned on the upstream end 480A side relative to the second fitting portion 452B.

The sealing main body member 459 surrounds the outer periphery of the fitting portion 452. The sealing main body member 459 is an annular member. The sealing main body member 459 (see FIG. 11) has an engagement portion 485 formed in the inner peripheral surface in the circumferential direction. In this embodiment, the engagement portion 485 is a groove. Note that, according to another embodiment, the engagement portion 485 may be a through hole that passes through the sealing main body member 459 in the circumferential direction. The engagement portion 485 is engaged with the engaging claw 493 of the supply member 49. The sealing main body member 459 surrounds the outer periphery of the fitting portion 452. As a result of the second supply opening portion 49B of the supply member 49 being fitted between the fitting portion 452 and the sealing main body member 459, the sealing main body member 459 biases the second supply opening portion 49B to the side on which the fitting portion 452 is positioned (radially inward). Accordingly, external force Fa directed radially inward is applied from the second supply opening portion 49B toward the second fitting portion 452B. Due to an action of this external force Fa, an outer peripheral surface 452Bfa of the fitting portion 452 (specifically, the second fitting portion 452B) and the inner peripheral surface 49Bfb of the second supply opening portion 49B come into surface contact with each other in the circumferential direction. In addition, in the periphery of the engaging claw 493, a third elastic sealing member 404 that seals the gap between the engaging claw 493 and the other end portion 45 of the intermediate member 48 is arranged. The third elastic sealing member 404 has a ring-like shape.

As shown in FIG. 11, the first elastic sealing member 405 is positioned on the first supply opening portion 49A side relative to the contact position between the outer peripheral surface 452Bfa of the second fitting portion 452B and the inner peripheral surface 49Bfb of the second supply opening portion 49B. In this embodiment, the first elastic sealing member 405 is arranged along the outer peripheral surface 452Afa of the first fitting portion 452A. In addition, the first elastic sealing member 405 is positioned between the outer peripheral surface 452Afa of the first fitting portion 452A and the inner peripheral surface 49Bfb of the second supply opening portion 49B, and seals the gap between the outer peripheral surface 452Afa and the inner peripheral surface 49Bfb. Accordingly, the first elastic sealing member 405 is pressed by the outer peripheral surface 452Afa and the inner peripheral surface 49Bfb in the radial direction of the fitting portion 452. Accordingly, the first elastic sealing member 405 applies an external force Fb to the fitting portion 452 radially inward.

The first fitting portion 452A (see FIG. 8) has a fitting-portion inner peripheral surface 452Afb that defines a portion of the supply flow path 480, a first rib 453 whose two ends are connected to the fitting-portion inner peripheral surface 452Afb, and a second rib 454 whose two ends are connected to the fitting-portion inner peripheral surface 452Afb. The fitting-portion inner peripheral surface 452Afb is positioned on the opposite side to the outer peripheral surface 452Afa of the fitting portion 452 in which the first elastic sealing member 405 is positioned. The second rib 454 intersects the first rib 453. The first rib 453 and the second rib 454 are plate-like members that intersect each other at a right angle, and pass through (the center of) the flow path of the first fitting portion 452A. The first fitting portion 452A of the fitting portion 452 has the first rib 453 and the second rib 454, and, as a result, it is possible to suppress deformation of the shape of the fitting portion 452 due to the external force Fb that is applied from the first elastic sealing member 405 to the fitting portion 452 (specifically, the first fitting portion 452A). Accordingly, it is possible to reduce the likelihood of variations in the degree of sealing of the first elastic sealing member 405, and thus it is possible to reduce the likelihood of liquid leaking from the gap between the fitting portion 452 and the supply member 49 to the outside.

The one end portion 46 of the intermediate member 48 (see FIGS. 8 and 11) has an opening 46P that has a larger opening area than the other end portion 45. The opening 46P forms the supply flow path 480 and a portion of the injection flow path 482 as shown in FIG. 11. The one end portion 46 has an engaging claw 483 protruding radially outward from an outer peripheral surface 46fa. The engaging claw 483 is formed over the entire outer peripheral surface 46fa. When the one end portion 46 is fitted into the connection member 41, the engaging claw 483 engages with the connection member 41.

The intermediate member 48 further has a pair of restriction portions 484 protruding in the X axis direction from the outer peripheral surface between the one end portion 46 and the other end portion 45. The pair of restriction portions 484 are plate-like members, and face the case 31 and restrict movement of the connection body 40 into the case 31.

As shown in FIG. 9, the connection member 41 has a substantially rectangular parallelepiped outer shape. The connection member 41 has a first surface (first wall) 411, a second surface (second wall) 412, a third surface (third wall) 413, a fourth surface (fourth wall) 414, a fifth surface (fifth wall) 415, and a sixth surface (sixth wall) 416.

In the attached state, the first surface 411 forms the end surface (upper surface) on the +Z axis direction side. In the attached state, the second surface 412 forms the end surface (bottom surface) on the −Z axis direction side. In the attached state, the third surface 413 forms the end surface (one side surface) on the −X axis direction side. In the attached state, the fourth surface 414 forms the end surface (the other side surface) on the +X axis direction side. In the attached state, the fifth surface 415 forms the end surface (front surface) on the +Y axis direction side. The first surface 411 and the second surface 412 are portions that face, in the Z axis direction, inner peripheral surfaces that form the housing space 21A of the attachment portion 20. The third surface 413 and the fourth surface 414 are portions that face, in the X axis direction, inner peripheral surfaces that form the housing space 21A of the attachment portion 20.

The connection member 41 includes the liquid supply portion 42 protruding from the fifth surface 415. Accordingly, the connection member 41 forms the downstream end (opening) 480B in the flow direction. In addition, the connection member 41 has the injection flow path 482 that includes the liquid injection portion 461.

The connection member 41 of the connection main body member 43 has a recessed portion 44 and a groove portion 418 that surrounds the outer periphery of the recessed portion 44. The recessed portion 44 and the groove portion 418 are formed in the sixth surface 416.

The recessed portion 44 has a bottom wall 441 opposing the upstream end 480A, and a frame-like side wall 433 that rises from the peripheral edge portion of the bottom wall 441. The bottom wall 441 (see FIG. 10) has a supply path opening 431 that is included in the supply flow path 480 and an injection path opening 421 that is included in the injection flow path 482. The supply path opening 431 and the injection path opening 421 are through holes that pass through the bottom wall 441. The side wall 433 rises from the peripheral edge portion of the bottom wall 441 on the −Y axis direction side (the upstream end 480A side).

In addition, in the liquid supply portion 42, a flow path 491 that brings the opening 480B and the supply path opening 431 into communication with each other is provided. Also, an opening/closing portion 500 is provided between the opening 480B and the supply path opening 431. The opening/closing portion 500 is configured such that the flow path 491 can transition between an open state and a closed state. In this embodiment, the opening/closing portion 500 includes a sealing member 501 provided in the vicinity of the opening 480B, a mobile body 510 that can come into contact with the end portion in the −Y axis direction of the sealing member 501, and a spring member 511 for moving the mobile body 510. The mobile body 510 has a substantially cylindrical body. In addition, the spring member 511 is arranged in the end portion in the −Y axis direction of the mobile body 510. The end portion in the −Y axis direction of the spring member 511 is restricted by a wall portion.

Additionally, in a state where the liquid introducing needle 223 is not inserted into the opening 480B of the liquid supply portion 42, the spring member 511 extends in the +Y axis direction, and presses the mobile body 510 in the +Y axis direction. Accordingly, in a state where the mobile body 510 presses the sealing member 501, the sealing member 501 and the mobile body 510 abut against each other, and the flow path 491 comes into a closed state. Accordingly, flow of liquid from the supply path opening 431 to the opening 480B is stopped, and the opening 480B is sealed.

On the other hand, in a state where the liquid introducing needle 223 is inserted into the opening 480B of the liquid supply portion 42, the mobile body 510 is pressed in the −Y axis direction by the liquid introducing needle 223. At this time, the spring member 511 shrinks in the −Y axis direction. Accordingly, abutment between the sealing member 501 and the mobile body 510 is released, and the flow path 491 comes into an open state. Accordingly, liquid can flow from the supply path opening 431 to the opening 480B.

Similarly, also in the liquid injection portion 461, a flow path 492 that brings an opening 482B and the injection path opening 421 into communication with each other is provided. Also, an opening/closing portion 600 is provided between the opening 482B and the injection path opening 421. The opening/closing portion 600 is configured such that the flow path 492 can transition between an open state and a closed state. In this embodiment, the opening/closing portion 600 has a sealing member 601 provided in the vicinity of the opening 482B, a mobile body 610 that can come into contact with the end portion in the −Y axis direction of the sealing member 601, and a spring member 611 for moving the mobile body 610. The mobile body 610 is a substantially cylindrical body. In addition, the spring member 611 is arranged in the end portion in the −Y axis direction of the mobile body 610. The end portion in the −Y axis direction of the spring member 611 is restricted by a wall portion.

In a state where a liquid supply needle is not inserted into the opening 482B of the liquid supply portion 42, the spring member 611 stretches in the +Y axis direction, and presses the mobile body 610 in the +Y axis direction. Accordingly, in the state where the mobile body 610 presses the sealing member 601, the sealing member 601 and the mobile body 610 abut against each other, and the flow path 492 comes into a closed state. Accordingly, the opening 482B is sealed.

On the other hand, in a state where the liquid supply needle is inserted into the opening 482B of the liquid injection portion 461, the mobile body 610 is pressed in the −Y axis direction by the liquid supply needle. At this time, the spring member 611 shrinks in the −Y axis direction. Accordingly, abutment between the sealing member 601 and the mobile body 610 is released, and the flow path 492 comes into an open state. Accordingly, liquid can flow from the opening 482B to the injection path opening 421.

The recessed portion 44 (see FIG. 10) also has a frame-like partition wall 445 that rises from the bottom wall 441, and surrounds the supply path opening 431. The partition wall 445 rises at a portion inward of the side wall 433 from the bottom wall 441 on the −Y axis direction side. Note that the injection path opening 421 is positioned outside of the frame-like partition wall 445. The filter FT is attached in an air-tight manner to an end portion 443A of the partition wall 445 on the opposite side to the side on which the bottom wall 441 is positioned. In FIG. 10, single hatching is added to a portion of the end portion 443A to which the filter FT is attached. As shown in FIG. 11, the filter FT is arranged on the downstream side relative to the fitting portion 452, in the supply flow path 480.

The connection member 41 of the connection main body member 43 (see FIGS. 9 and 10) further has first projections 447 provided in the recessed portion 44 and positioned in the outer periphery of the filter FT. Eight first projections 447 are provided. Two first projections 447 are arranged to face each of the four sides of the filter FT that has a rectangular shape. The first projections 447 restrict movement of the filter FT in a direction orthogonal to the flow direction of the supply flow path 480 (a direction parallel to the X axis direction and the Z axis direction). For example, when the filter FT is arranged in the end portion 443A and is attached to the end portion 443A, it is possible to restrict deviation of the filter FT as a result of the first projections 447 restricting movement of the filter FT. In addition, for example, in the case where the filter FT attached to the end portion 443A is attempting to move in a direction parallel to the X axis direction and the Z axis direction due to external force, deviation of the filter FT can be suppressed as a result of the filter FT hitting the first projections 447. Accordingly, it is possible to suppress deviation of the filter FT, and thus it is possible to reduce the likelihood of a gap being formed between the filter FT and the end portion 443A. Thus, the filter FT can suppress passage of extraneous materials, and thus it is possible to reduce the likelihood of extraneous materials reaching the attachment portion 20.

The groove portion 418 (see FIG. 10) is adjacent to the recessed portion 44. The groove portion 418 (see FIG. 10) has a bottom wall 417, and a side wall 419 and the side wall 433 that rise from the peripheral edge portions of the bottom wall 417. The side wall 433 is shared with the recessed portion 44. The bottom wall 417 opposes the one end portion 46 of the intermediate member 48 (see FIG. 11). The side wall 419 is positioned at the outer edge of the groove portion 418, and has a frame-like shape. The side wall 419 has second projections 449 protruding inward in the groove portion 418. Seven second projections 449 are provided with spaces therebetween. The second projections 449 are portions that engage with the engaging claw 483 of the intermediate member 48 (see FIG. 11). The second projections 449 are connected to the intermediate member 48 by being engaged with the engaging claw 483. One of the second projections 449 is positioned on the +Z axis direction side relative to the recessed portion 44, two below the recessed portion 44 (on the −Z axis direction side), two on the +X axis direction side relative to the recessed portion 44, and two on the −X axis direction side relative to the recessed portion 44. Note that the number of second projections 449 is not limited the above number as long as engagement with the engaging claw 483 of the intermediate member 48 can be stably maintained. For example, one second projection 449 may be provided on each of the +Z axis direction side, the −Z axis direction side, the +X axis direction side, and the −X axis direction side relative to the recessed portion 44, and second projections 449 may be formed continuously to follow the shape of the groove portion 418.

The second elastic sealing member 403 (see FIG. 11) is arranged in the groove portion 418. Specifically, the gap between the groove portion 418 of the connection member 41 and the intermediate member 48 is sealed in the state of the second elastic sealing member 403 being pressed by the bottom wall 417 of the groove portion 418 and the one end portion 46 of the intermediate member 48 that opposes the bottom wall 417, in the axial direction of the intermediate member 48 (the thrust direction: the flow direction of the supply flow path 480). The second elastic sealing member 403 is arranged to surround the supply flow path 480 and the injection flow path 482. The second elastic sealing member 403 makes it possible to reduce the likelihood of liquid in the supply flow path 480 and the injection flow path 482 leaking to the outside.

The above-described second projections 449 (see FIG. 11) are positioned on the intermediate member 48 side relative to the second elastic sealing member 403.

In the flow direction of the supply flow path 480, the injection flow path 482 (see FIG. 11) is joined to the supply flow path 480 upstream of the filter FT. Accordingly, in the flow direction of the supply flow path 480, the injection flow path 482 on the upstream side is the same as the supply flow path 480, and the injection flow path 482 branches at the injection path opening 421. A branching flow path is formed in the liquid injection portion 461.

As described above, in the liquid container 30, the connection body 40 that forms the supply flow path 480 through which liquid from the liquid supply source 32 flows has the sealing main body member 459 and the first elastic sealing member 405 (see FIG. 11). The sealing main body member 459 brings the outer peripheral surface 452Bfa of the fitting portion 452 (specifically, the second fitting portion 452B) and the inner peripheral surface 49Bfb of the second supply opening portion 49B into contact with each other in the circumferential direction. In addition, the first elastic sealing member 405 seals the gap between the outer peripheral surface 452Afa of the fitting portion 452 (specifically, the first fitting portion 452A) and the inner peripheral surface 49Bfb of the second supply opening portion 49B. Accordingly, compared with the case of suppressing leakage of liquid to the outside by covering the liquid supply source 32 and the connection body 40 with a sealed case, leakage of liquid to the outside can be suppressed in a small region (specifically, in a region in which the connection body 40 is positioned). Accordingly, it is possible to reduce the likelihood that a function for suppressing leakage to the outside due to deviation between members, tolerances of members, and the like is not sufficiently exerted. In addition, the connection body 40 has a sealing structure realized by the first elastic sealing member 405 and a sealing structure realized through surface contact in the circumferential direction between the outer peripheral surface 452Bfa of the second fitting portion 452B and the inner peripheral surface 49Bfb of the second supply opening portion 49B by the sealing main body member 459, and as a result, it is possible to further suppress leakage of liquid to the outside.

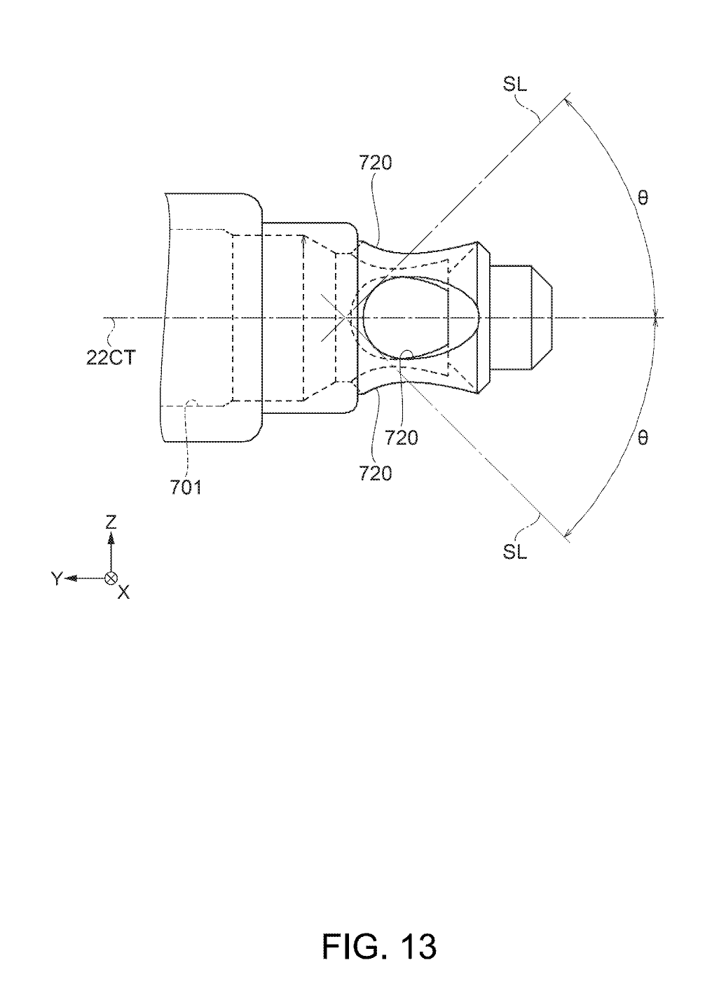

Next, the configuration of the liquid introducing needle 223 will be described in detail. FIG. 12 is a perspective view showing the configuration of the liquid introducing needle 223. In addition, FIG. 13 is a partial cross-sectional view showing the configuration of the liquid introducing needle 223.

As shown in FIGS. 12 and 13, the liquid introducing needle 223 has a cylindrical shape, and includes the central axis 22CT extending along the Y axis direction. This central axis 22CT is an axial line in which the radial center of the leading end portion of the liquid introducing needle 223 (to be described later) is the axial center. A flow path 701 through which liquid flows is formed in the liquid introducing needle 223. The proximal end portion 702 is arranged in the end portion in the +Y axis direction side of the liquid introducing needle 223, and is connected to the first tube 98 (ink flow path).

On the opposite side to the proximal end portion 702 of the liquid introducing needle 223, a leading end portion 710 that is to be inserted into the opening 480B of the liquid supply portion 42 is provided. In addition, liquid communication ports 720 (ink communication ports) through which liquid can flow from the outside to the flow path 701 (or from the flow path 701 to the outside) are formed in the leading end portion 710. More specifically, in the state where the liquid introducing needle 223 is inserted into the opening 480B of the liquid supply portion 42, the liquid communication ports 720 are formed inward of the sealing member 501, which will be described later, in the liquid supply portion 42 (the −Y axis direction side). A plurality of (in this embodiment, four) liquid communication ports 720 are formed in the circumferential direction of the leading end portion 710. Accordingly, the flow amount of liquid increases, and the flow speed of liquid can be increased.

In addition, as shown in FIG. 13, a virtual axial line SL that passes through the center of a liquid communication port 720 is inclined relative to the central axis 22CT of the liquid introducing needle 223. Specifically, an angle θ between the virtual axial line SL and the central axis 22CT of the liquid introducing needle 223 is 45°±10°.

In addition, an extended line of the inner wall surface (a thick portion between the inside and the outside of the liquid introducing needle 223) of a liquid communication port 720 is inclined relative to the central axis 22CT of the liquid introducing needle 223.

Note that the number of liquid communication ports 720 may be one, and there is no limitation to the case where four liquid communication ports 720 are provided in this embodiment, and a smaller (e.g., two, three) or larger (e.g., five or more) number of liquid communication ports 720 may be provided. In addition, the shape, size, and position of the liquid communication ports 720, and the angle θ between the virtual axial line SL of a liquid communication port 720 and the central axis 22CT of the liquid introducing needle 223 is not limited to the angle in this embodiment, and if resistance to the flow of ink can be reduced in accordance with the spirit of the present invention, another mode may be used. If a plurality of liquid communication ports 720 are provided, the lengths between the liquid communication ports 720 and the angles θ between the virtual axial lines SL that pass through the centers of the liquid communication ports 720 and the central axis 22CT of the liquid introducing needle 223 do not necessarily need to be the same. In addition, a plurality of liquid communication ports 720 may be formed along the +Y axis direction.

In addition, the external diameters in the Y axis direction of the wall surfaces of portions of the liquid introducing needle 223 in which the liquid communication ports 720 are formed may be the same, or may be different (in other words, a face tapered or inclined in the Y axis direction may be formed).

Note that the angle between the virtual axial line SL and the central axis 22CT of the liquid introducing needle 223 may be an angle other than the above-described angle (0°<θ<90°) if the spirit of the present invention for reducing resistance to flow of ink is fulfilled.

In addition, a tip portion 722 of the leading end portion 710 of the liquid introducing needle 223 (more specifically, the end portion on the −Y axis direction side) is flat. Accordingly, when the liquid introducing needle 223 is inserted into the opening 480B of the liquid supply portion 42, the liquid introducing needle 223 comes into surface contact with the end portion on the +Y axis direction side of the mobile body 510, and it is possible to stabilize the connectability with the liquid supply portion 42 of the connection body 40. In addition, in this embodiment, in the end portion on the +Y axis direction side of the mobile body 510, a recessed portion into which the tip portion 722 of the leading end portion 710 of the liquid introducing needle 223 enters is formed. In addition, in the end portion on the +Y axis direction side of the recessed portion, a leading end portion of the leading end portion 710 of the liquid introducing needle 223 is supported.

Note that, in this embodiment, the tip portion of the leading end portion 710 of the liquid introducing needle 223 is flat, but the tip portion of the leading end portion 710 of the liquid introducing needle 223 may have a shape other than a flat shape. In addition, a recessed portion does not need to be formed in the end portion on the +Y axis direction side of the mobile body 510, and the leading end portion 710 of the liquid introducing needle 223 does not need to be supported in the end potion on the +Y axis direction side of the recessed portion.

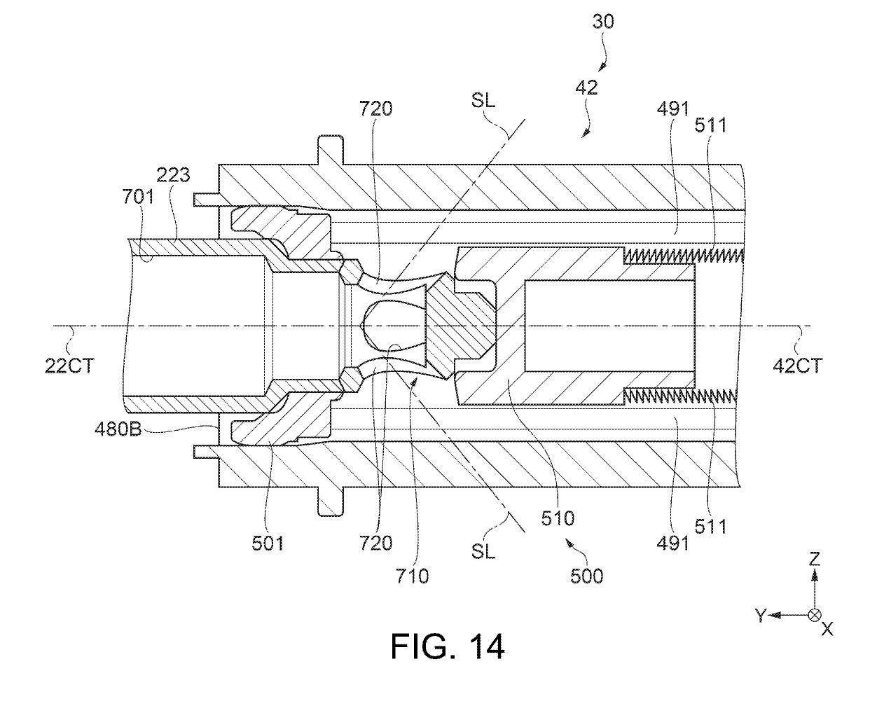

Next, a state will be described in which the liquid introducing needle 223 is connected to the connection body 40. In other words, a state will be described in which the flow path 491 comes into an open state. FIG. 14 is a cross-sectional view showing a state where a liquid introduction needle is inserted into a connection body.

As shown in FIG. 14, the leading end portion 710 of the liquid introducing needle 223 is inserted into the opening 480B. Furthermore, specifically, the leading end portion 710 of the liquid introducing needle 223 presses the mobile body 510 in the −Y axis direction. Accordingly, as the spring member 511 shrinks, the mobile body 510 moves in the −Y axis direction. The sealing member 501 and the mobile body 510 are then spaced apart, and the flow path 491 enters an open state. Specifically, the flow path 491 of the liquid supply portion 42 and the flow path 701 of the liquid introducing needle 223 come into communication with each other via the liquid communication ports 720, and liquid contained in the liquid container 30 can flow to the first tube 98 side.

Here, in the state where the liquid introducing needle 223 is connected to the connection body 40 (the leading end portion 710 is inserted into the opening 480B), the central axis 22CT of the liquid introducing needle 223 and an axial line 42CT in which the center of the opening 480B of the liquid supply portion 42 is the axial center fall on the same line. Note that “fall on the same line” refers to matching in a range including tolerances of the liquid introducing needle 223, the opening 480B, and the like.

Moreover, in the state where the liquid introducing needle 223 is connected to the connection body 40 (the central axis 22CT of the liquid introducing needle 223 and the axial line 42CT in which the center of the opening 480B of the liquid supply portion 42 is the axial center are on the same line), the virtual axial line SL that passes through the center of a liquid communication port 720 is inclined relative to the axial line 42CT in which the center of the opening 480B of the liquid supply portion 42 is the axial center.

In addition, space is provided on extended lines of the liquid communication ports 720. In other words, a portion that hinders the flow of liquid, or the like is not formed between the liquid communication ports 720 and the flow path 491 of the liquid supply portion 42. More specifically, if the outer contours of the liquid communication ports 720 are extended to the inner wall of the liquid supply portion 42 at the angle θ (the angle of inclination of the virtual axial line SL that passes through the center of the liquid communication port 720 relative to the central axis 22CT of the liquid introducing needle 223), at least a portion of a virtual region acquired by extending the outer contours of the liquid communication ports 720 does not include a portion that hinders the flow of ink, or the like. Therefore, when liquid flows from the flow path 491 via the liquid communication ports 720, it is possible to reduce resistance to a flowing liquid.

Accordingly, in the state where the liquid introducing needle 223 is inserted into the opening 480B (connection port) of the connection body 40, a space in which ink flows is formed in at least a portion of a virtual region acquired by extending the outer contours of the liquid communication ports 720 toward the inner wall of the liquid supply portion 42 at the angle between the virtual axial lines SL that pass through the centers of the liquid communication ports 720 and the central axis 22CT of the liquid introducing needle 223.

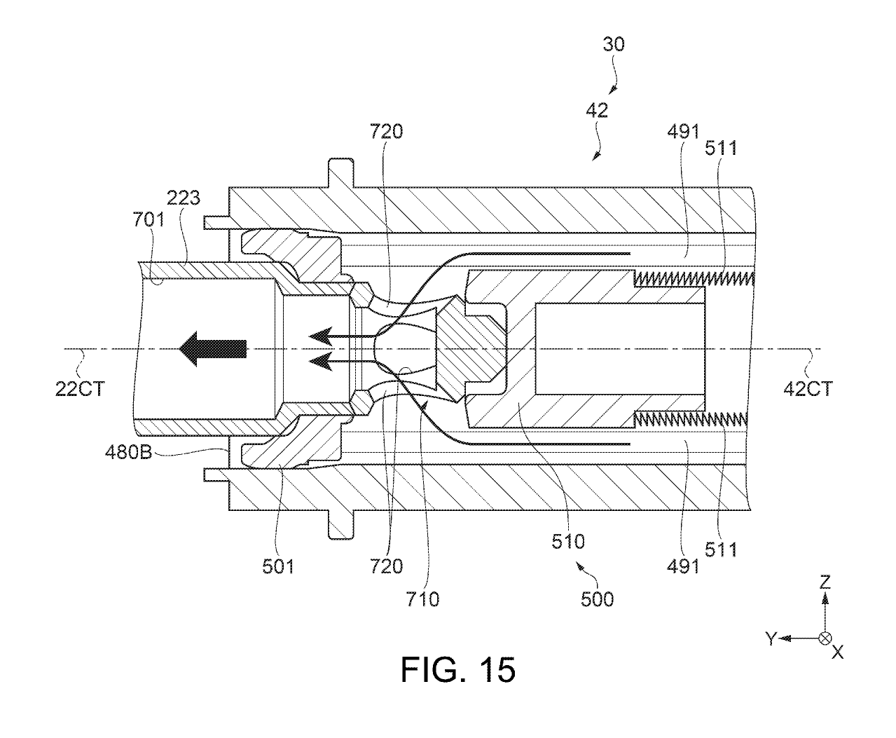

Next, an action of a liquid introduction needle will be described. FIG. 15 is a schematic diagram showing an action of a liquid introduction needle.

As shown in FIG. 15, when the leading end portion 710 of the liquid introducing needle 223 is inserted into the opening 480B, the mobile body 510 moves in the −Y axis direction while the leading end portion 710 of the liquid introducing needle 223 abuts against an end portion of the mobile body 510. Here, the tip portion 722 of the leading end portion 710 is flat, and the surface of the mobile body 510 that comes into contact with the tip portion 722 of the leading end portion 710 is also flat. Therefore, the tip portion 722 of the leading end portion 710 and the mobile body 510 come into surface contact, and thus it is possible to move the liquid introducing needle 223 and the mobile body 510 the −Y axis direction in a stable manner.

Subsequently, the leading end portion 710 of the liquid introducing needle 223 is inserted to a predetermined position. Note that the predetermined position is a position at which all of the liquid communication ports 720 of the liquid introducing needle 223 oppose the flow path 491 of the liquid supply portion 42, and is a position at which the flow path 491 of the liquid supply portion 42 enters an open state.

When the leading end portion 710 of the liquid introducing needle 223 is inserted to the predetermined position, liquid moves from the flow path 491 of the liquid supply portion 42 to the flow path 701 side of the liquid introducing needle 223 via the liquid communication ports 720.

At this time, the virtual axial lines SL that pass through the centers of the liquid communication ports 720 are inclined relative to the axial line 42CT in which the center of the opening 480B of the liquid supply portion 42 is the axial center, and thus liquid that flows from the flow path 491 of the liquid supply portion 42 flows to the liquid communication ports 720, in directions inclined relative to the flow path 701 of the liquid introducing needle 223. In addition, space is provided on extended lines of the liquid communication ports 720, and thus liquid flows smoothly. Liquid that has been introduced from the liquid communication ports 720 then flows to the first tube 98 via the flow path 701.

As described above, according to this embodiment, the following effect can be obtained.

The virtual axial lines SL that pass through the centers of the liquid communication ports 720 are inclined relative to the axial line 42CT in which the center of the opening 480B of the liquid supply portion 42 is the axial center, and thus resistance to flowing liquid is reduced. Therefore, it is possible to increase the flow speed of liquid that flows from the liquid container 30 toward the sub tank 18a side. Therefore, an increase in the supply speed of liquid that is flowing to the liquid consumption portion 14 is contributed to, and the printing speed can be increased.

### Second Embodiment

In the above first embodiment, a configuration has been described in which liquid contained in the liquid container 30 is caused to flow to the outside (the sub tank 18a) using the liquid introducing needle 223, but in this embodiment, a configuration will be described in which liquid is caused to flow from the outside to the liquid container 30 using the liquid introducing needle 223, in other words the configuration of a liquid-filling jig (ink-filling jig) will be described.

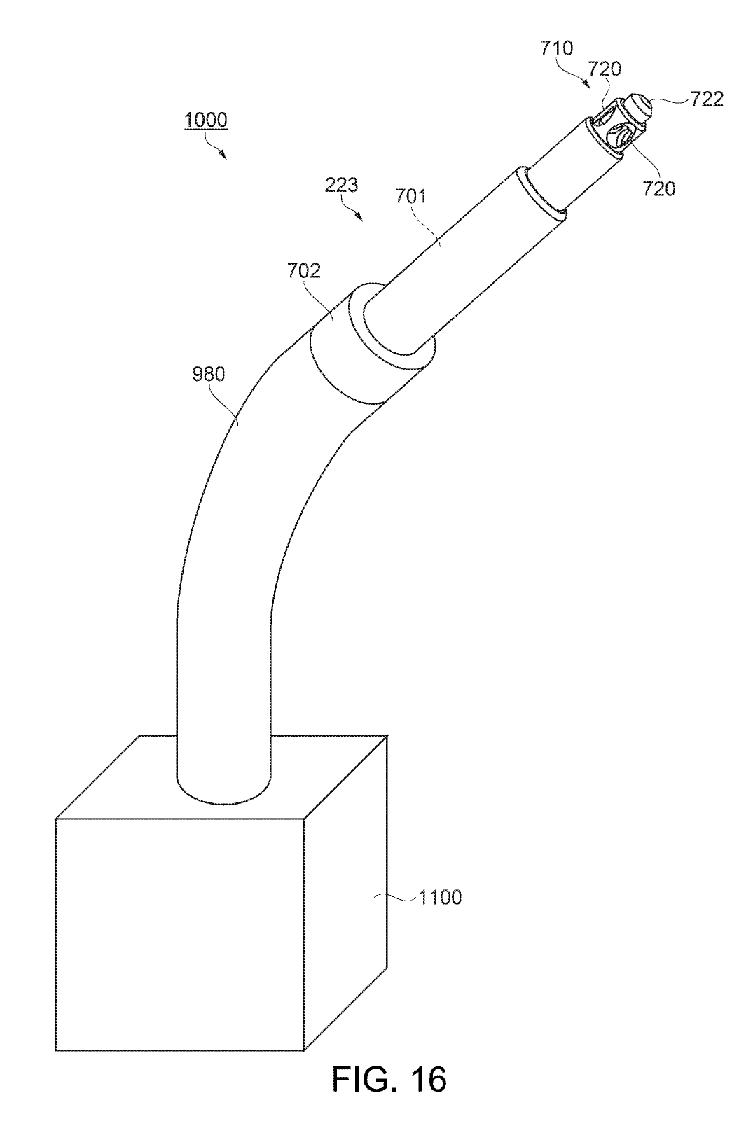

FIG. 16 is a schematic diagram showing the configuration of a liquid-filling jig (ink-filling jig). Note that the same reference numerals are given to constituent elements that are the same as those in the first embodiment.

As shown in FIG. 16, a liquid-filling jig 1000 includes a liquid introducing needle 223, a liquid tank 1100 (ink tank), and a tube 980 that connects the liquid introducing needle 223 and the liquid tank 1100. Note that the configuration of the liquid introducing needle 223 is similar to that according to the first embodiment, and thus a description thereof is omitted (see FIGS. 12 and 13).

The liquid tank 1100 is a container that can contain liquid such as ink. The amount of liquid that can be contained can be set as appropriate.

The tube 980 is a tube through which liquid can flow. One end portion of the tube 980 is connected to a proximal end portion 702 of the liquid introducing needle 223, and the other end portion of the tube 980 is connected to the liquid tank 1100. Liquid can flow from the liquid tank 1100 toward the liquid introducing needle 223 side through the tube 980 using a pump or the like (not shown).

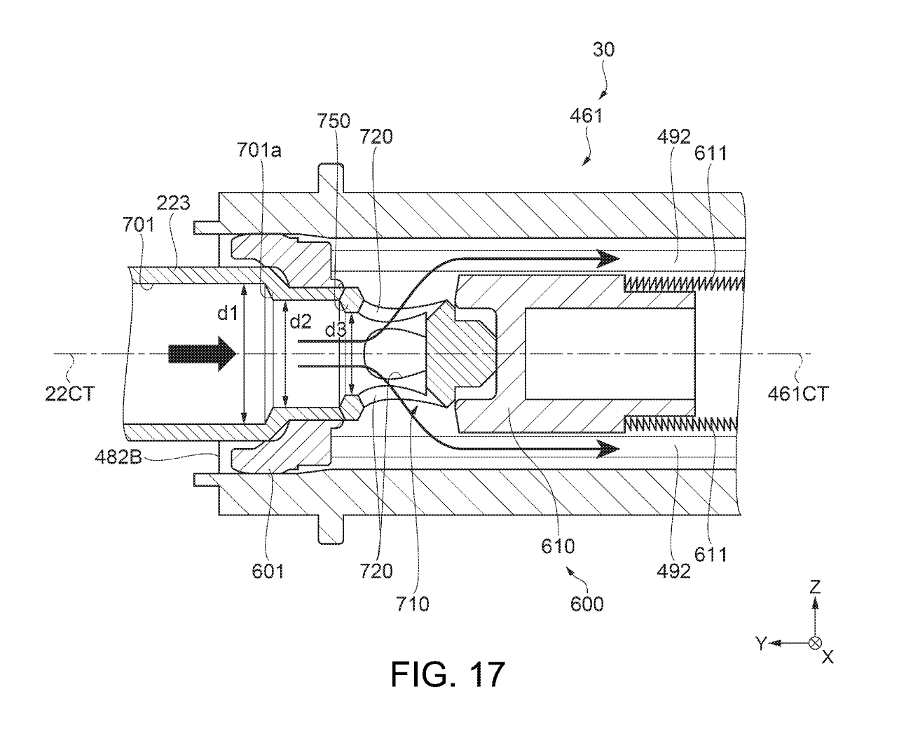

FIG. 17 is a schematic diagram showing an action of a liquid-filling jig.

As shown in FIG. 17, the leading end portion 710 of the liquid introducing needle 223 is inserted into an opening 482B of a liquid injection portion 461. Furthermore, specifically, the leading end portion 710 of the liquid introducing needle 223 presses a mobile body 610 in the −Y axis direction. Accordingly, as a spring member 611 shrinks, the mobile body 610 moves in the −Y axis direction. A sealing member 601 and the mobile body 610 are then spaced apart, and a flow path 492 enters an open state. Specifically, the flow path 492 of the liquid injection portion 461 and a flow path 701 of the liquid introducing needle 223 are brought into communication with each other via liquid communication ports 720, and liquid contained in the liquid tank 1100 can flow toward the liquid container 30.

Here, in the state where the liquid introducing needle 223 is connected to a connection body 40 (the state where the leading end portion 710 is inserted into the opening 482B), a central axis 22CT of the liquid introducing needle 223 and an axial line 461CT in which the center of the opening 482B of the liquid injection portion 461 is the axial center fall on the same line. Note that “falling on the same line” refers to machining in a range including tolerances of the liquid introducing needle 223, the opening 482B, and the like.

In the state where the liquid introducing needle 223 is connected to the connection body 40, the virtual axial line SL that passes through the center of a liquid communication port 720 is inclined relative to the axial line 461CT in which the center of the opening 482B of the liquid injection portion 461 is the axial center.

In addition, space is provided on extended lines of the liquid communication ports 720. Accordingly, in the liquid-filling jig 1000 in this embodiment, in the state where the liquid introducing needle 223 is inserted into the opening 480B (connection port) of the connection body 40, a space in which ink flows is formed in at least a portion of a virtual region acquired by extending the outer contours of the liquid communication ports 720 toward the inner wall of the liquid supply portion 42 at the angle between the virtual axial lines SL that pass through the centers of the liquid communication ports 720 and the central axis 22CT of the liquid introducing needle 223. Accordingly, a portion that hinders the flow of liquid, or the like is not formed between the liquid communication ports 720 and the flow path 492 of the liquid injection portion 461. Therefore, when liquid flows from the liquid communication ports 720 to the flow path 492, it is possible to reduce resistance to the flowing liquid.

In addition, the tube diameter of the flow path 701 in the leading end portion 710 of the liquid introducing needle 223 is smaller than the tube diameter on the proximal end portion 702 side. Here, the tube diameter of the flow path 701 refers to an internal diameter of a portion of the liquid introducing needle 223 in which ink in flows. Specifically, the tube diameter on the proximal end portion 702 side is denoted by d1. In addition, the tube diameter on the leading end portion 710 side is smaller than the tube diameter d1, and is denoted by d2 (d2<d1). On the −Y axis direction side of a flow path 701a having the tube diameter d2, the flow path 701a being in an end portion in the +Y axis direction relative to the liquid communication ports 720, a projecting throttle portion 750 is formed inside the flow path 701a. Therefore, the tube diameter of a portion in which the throttle portion 750 is formed is smaller than the tube diameter d2, and is denoted by d3 (d3<d2). Therefore, the tube diameter d3 in the vicinity of the liquid communication ports 720 is smaller than the tube diameter d1 on the proximal end portion 702 side, and thus the flow speed of liquid increases (d3<d1). Accordingly, it is possible to increase the flow speed of liquid that flows to the flow path 492 of the liquid injection portion 461.

Note that, in this embodiment, the liquid introducing needle 223 has the three tube diameters d1, d2, and d3 from the proximal end portion 702 to the leading end portion 710, and the tube diameter decreases gradually, but there is no limitation thereto, and the liquid introducing needle 223 may have a linear shape with only one tube diameter, or may be a liquid introduction needle with two tube diameters.

Note that the state where the liquid introducing needle 223 is connected to the connection body 40 refers to a state where the leading end portion 710 of the liquid introducing needle 223 is inserted to a predetermined position. Note that the predetermined position refers to a position at which the all of the liquid communication ports 720 of the liquid introducing needle 223 oppose the flow path 492 of the liquid injection portion 461, and the flow path 492 of the liquid injection portion 461 enters an open state.

Moreover, when the leading end portion 710 of the liquid introducing needle 223 is inserted to the predetermined position, and a pump (not shown) is driven, liquid passes through the tube 980 from the liquid tank 1100, and flows to the flow path 492 side of the liquid injection portion 461 via the liquid communication ports 720.

At this time, the virtual axial lines SL that pass through the centers of the liquid communication ports 720 are inclined relative to the axial line 461CT in which the center of the opening 482B of the liquid injection portion 461 is the axial center, and thus liquid caused to flow along the central axis 22CT of the liquid introducing needle 223 flows from the liquid communication ports 720 in a direction inclined relative to the flow path 492 of the liquid injection portion 461. Accordingly, liquid moves along the virtual axial lines SL that are inclined relative to the central axis 22CT of the liquid introducing needle 223. In addition, space is provided on the extended lines of the liquid communication ports 720, and thus liquid flows smoothly. Liquid that has flowed from the liquid communication ports 720 then flows into a liquid supply source 32 through the injection flow path 482.

As described above, according to this embodiment, the following effects can be obtained.

The virtual axial lines SL that pass through the liquid communication ports 720 are inclined relative to the axial line 461CT in which the center of the opening 482B of the liquid injection portion 461 is the axial center, and thus resistance to flowing liquid is reduced. Therefore, it is possible to increase the flow speed of liquid that flows from the liquid tank 1100 to the liquid container 30 side. Therefore, it is possible to increase the filling speed of the liquid container 30.

In addition, in this embodiment, the liquid introducing needle 223 has three tube diameters d1, d2, and d3 from the proximal end portion 702 to the leading end portion 710, and the diameter decreases gradually, and thus it is possible to gradually increase the flow speed of ink, and make ink flow more smoothly.

In addition, by filling liquid using the liquid-filling jig 1000 provided with the liquid introducing needle 223, it is possible to increase the productivity of the liquid container 30.

Note that the present invention is not limited to the above embodiments, and various modifications, improvements, and the like can be added to the above embodiments. Modified examples will be given below.

### Modified Example 1

According to the liquid-filling jig 1000 in the second embodiment, liquid is caused to flow using a pump (not shown), but there is no limitation thereto. For example, a configuration may be adopted in which a cylindrical tube (syringe) and a movable pusher (plunger) are included. Note that the liquid introducing needle 223 is connected to the syringe. As a result of liquid being contained in the syringe, and being pressed by the plunger, the liquid is discharged from the liquid communication ports 720 of the liquid introducing needle 223 connected to the syringe. Also with such a configuration, an effect similar to the above effect can be obtained.

### Modified Example 2

The application of the present invention is not limited to a textile printing machine, and a liquid container or a connection body for supplying liquid to a textile printing machine. The present invention is also applicable to any liquid consumption apparatus, and a liquid container and a connection body that can be attached/detached to/from an attachment portion of a liquid consumption apparatus. The present invention is also applicable to the following various types of liquid consumption apparatuses, and liquid containers and connection bodies of the liquid consumption apparatuses.

(1) an image recording apparatus such as a facsimile apparatus; (2) a colorant consumption (ejection) apparatus used to produce a color filter for an image display apparatus such as a liquid crystal display; (3) an electrode material consumption apparatus used to form electrodes for an organic EL (electro luminescent) display, a surface emission display (field emission display, FED), or the like; (4) a liquid consumption apparatus that injects a liquid containing a biological organism for use in biochip fabrication; (5) a sample consumption apparatus as a precision pipette; (6) a lubricating oil consumption (ejection) apparatus; (7) a resin solution consumption (ejection) apparatus; (8) a liquid consumption apparatus that injects lubricating oil to a precision machine such as a timepiece or a camera with pinpoint accuracy; (9) a liquid consumption apparatus that injects a transparent resin solution such as an ultraviolet curable resin solution onto a substrate so as to form a micro hemispherical lens (optical lens) used in an optical communication element, or the like; (10) a liquid consumption apparatus that injects an acid or alkaline etching solution so as to etch a substrate or the like; and (11) a liquid consumption apparatus that includes a liquid injection head that ejects a micro amount of droplets of any liquid.

As used herein, the term “droplets” refers to a state of a liquid discharged by a liquid consumption apparatus, and encompasses granule-like droplets, tear drop-like droplets, and filament-like elongated droplets. Also, the term “liquid” as used herein may be any material that can be ejected by a liquid consumption apparatus. For example, the term “liquid” may be a material in which the substance is in a liquid phase. Materials in a liquid state that have high or low viscosity, and materials in a liquid state such as sol, gel water, other inorganic solvents, organic solvents, solutions, liquid resins, liquid metals (metal melts) are also encompassed in the term “liquid”. Also, the term “liquid” also encompasses, not only liquids as one state of a substance, but also liquids obtained by dissolving, dispersing or mixing particles of a functional material made of a solid substance such as a pigment or metal particles in a solvent. Typical examples of the liquid include ink described in the embodiments given above, liquid crystal, and the like. As used herein, the term “ink” encompasses ordinary water-based ink and oil-based ink, as well as various types of liquid compositions such as gel ink, and hot melt ink.

The present application is based on, and claims priority from JP Application Serial Number 2018-028550, filed 2, 21, 2018, the disclosure of which is hereby incorporated by reference herein in its entirety.

1. An ink connection needle that is connected to a cartridge provided with an ink container that contains ink, a connection body connected to the ink container, and a sealing member that seals the connection body, such that one end of the ink connection needle is detachably connected to a connection port of the connection body, the other end is connected to an ink flow path, and the ink can flow between the cartridge and an ink tank connected to the ink flow path, the ink connection needle comprising:
a base end portion connected to the ink flow path and positioned on the ink tank side; and
a leading end portion in which an ink communication port is formed, and that passes through the sealing member and is inserted into the connection port,
wherein, in a state where the leading end portion is inserted into the connection port,
a virtual axial line that passes through a center of the ink communication port is inclined relative to an axial line in which a radial center of the leading end portion is an axial center.

2. The ink connection needle according to claim 1,
wherein a plurality of ink communication ports are formed in a circumferential direction of the leading end portion.

3. The ink connection needle according to claim 1,
wherein a tip portion of the leading end portion is flat.

4. The ink connection needle according to claim 1,
wherein a space in which the ink flows is formed in at least a portion of a virtual region acquired by extending an outer contour of the ink communication port toward an inner wall of the connection body at an angle between a virtual axial line that passes through a center of the ink communication port and an axial line in which a center of the connection port of the connection body is an axial center.

5. An ink-filling jig that is connected to a cartridge provided with an ink container that contains ink, a connection body connected to the ink container, and a sealing member that seals the connection body, such that one end of the ink-filling jig is detachably connected to a connection port of the connection body, the other end is connected to an ink flow path, and the ink can flow from an ink tank connected to the ink flow path to the cartridge,
the ink-filling jig comprising:
an ink connection needle that is connected to the connection body,
wherein the ink connection needle includes:
a base end portion that is connected to the ink flow path and positioned on the ink tank side, and
a leading end portion in which an ink communication port is formed, and that passes through the sealing member, and is inserted into the connection port, and
in a state where the leading end portion is inserted into the connection port,
a virtual axial line in which a center of the ink communication port is an axial center is inclined relative to an axial line in which a center of the connection port of the connection body is an axial center.

6. The ink-filling jig according to claim 5,
wherein a tube diameter of the leading end portion of the ink connection needle through which the ink flows is smaller than a tube diameter of the base end portion through which the ink flows.

7. The ink-filling jig according to claim 5,
wherein a space in which the ink flows is formed in at least a portion of a virtual region acquired by extending an outer contour of the ink communication port toward an inner wall of the connection body at an angle between a virtual axial line that passes through a center of the ink communication port and an axial line in which a center of the connection port of the connection body is a central axis.

8. A cartridge that is filled with the ink using the ink connection needle according to claim 1.

9. A cartridge that is filled with the ink using the ink connection needle according to claim 2.

10. A cartridge that is filled with the ink using the ink connection needle according to claim 3.

11. A cartridge that is filled with the ink using the ink connection needle according to claim 4.

12. A cartridge that is filled with the ink using the ink connection needle according to claim 1.

13. A cartridge that is filled with the ink using the ink connection needle according to claim 2.

14. A cartridge that is filled with the ink using the ink connection needle according to claim 3.

15. A cartridge that is filled with the ink using the ink connection needle according to claim 4.

16. A cartridge that is filled with the ink using the ink connection needle according to claim 1.

17. A cartridge that is filled with the ink using the ink connection needle according to claim 2.

18. A cartridge that is filled with the ink using the ink connection needle according to claim 3.

19. A cartridge that is filled with the ink using the ink connection needle according to claim 4.
